(19) United States
(12) Patent Application Publication
(10) Pub. No.: US 2026/0244516 A1
(43) Pub. Date: Aug. 20, 2026

(54) MICROSERVICE ORCHESTRATION

(71) Applicant: INTERNATIONAL BUSINESS MACHINES CORPORATION, Armonk, NY (US)

(72) Inventors: Pijush Kanti BISWAS, New Delhi (IN); Saurabh TREHAN, Gurgaon (IN); Rohit KAUSHIK, Gurgaon (IN)

(21) Appl. No.: 19/058,583

(22) Filed: Feb. 20, 2025

(51) Int. Cl. G06F 9/54

(52) U.S. Cl. CPC G06F 9/542

(57) ABSTRACT

Methods, computer program products, and systems are presented, which can include, for instance: establishing, for a microservice defining a microservice based application hosted in a source state, edge characterizing data that characterizes a relationship of the microservice to respective ones of remaining microservices defining the microservice based application, wherein the establishing is performed in dependence on observatory data obtained for the microservice based application hosted in the source state; repeating the establishing for second to Nth microservices defining the microservice based application, and outputting from the repeating an application characterizing dataset that characterizes the microservice based application hosted in the source state; generating a plurality of candidate rehosting states for the microservice based application; for respective ones of the candidate rehosting states, producing a candidate application characterizing dataset; and identifying, in dependence on the producing, a suitable rehosting state from the plurality of candidate rehosting states.

### BACKGROUND

Embodiments herein relate to orchestration generally and specifically to intelligent orchestration of applications defined by interoperating microservices.

There are a plurality of cloud based computer environment providers on the market today, each of them offering specific services with service levels, targeting specific use cases, groups of clients, vertical and geographic markets. These cloud providers compete with services of traditional IT service providers which are operated typically in on-premises environments of client owned datacenters. While cloud providers seem to have advantages over said company-owned datacenters, they are not under direct control of the client companies and there is a substantial risk of failure to provide agreed service levels. Furthermore, cloud service providers might change their service levels, prices, and service offerings more often than traditional on-premises (owned by the service consumer) information technology providers.

With the advent of cloud computing, the information technology industry has been undergoing structural changes. These changes not only affect information technology companies themselves, but also the industry in general for which information technology has become an essential part of their business operations. IT departments face the need of providing infrastructure faster, driven by their lines of business, internal clients, suppliers and external customers. On the other hand, the pressure on cost effectiveness and quality of service continues to be very high. A high level of security is of utmost importance. Cloud computer environments have to fulfill similar requirements as traditional data centers in this regard, but are perceived to provide services faster and cheaper, and to have virtually endless resources available.

Data structures have been employed for improving operation of computer system. A data structure refers to an organization of data in a computer environment for improved computer system operation. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: establishing, for a microservice defining a microservice based application hosted in a source state, edge characterizing data that characterizes a relationship of the microservice to respective ones of remaining microservices defining the microservice based application, wherein the establishing is performed in dependence on observatory data obtained for the microservice based application hosted in the source state; repeating the establishing for second to Nth microservices defining the microservice based application, and outputting from the repeating an application characterizing dataset that characterizes the microservice based application hosted in the source state; generating a plurality of candidate rehosting states for the microservice based application; for respective ones of the candidate rehosting states, producing a candidate application characterizing dataset; identifying, in dependence on the producing, a suitable rehosting state from the plurality of candidate rehosting states; and rehosting the microservice based application for implementation of the suitable rehosting state identified by the identifying.

In another aspect, a computer program product can be provided. The computer program product can include a computer readable storage medium readable by one or more processing circuit and storing instructions for execution by one or more processor for performing a method. The method can include, for example: establishing, for a microservice defining a microservice based application hosted in a source state, edge characterizing data that characterizes a relationship of the microservice to respective ones of remaining microservices defining the microservice based application, wherein the establishing is performed in dependence on observatory data obtained for the microservice based application hosted in the source state; repeating the establishing for second to Nth microservices defining the microservice based application, and outputting from the repeating an application characterizing dataset that characterizes the microservice based application hosted in the source state; generating a plurality of candidate rehosting states for the microservice based application; for respective ones of the candidate rehosting states, producing a candidate application characterizing dataset; identifying, in dependence on the producing, a suitable rehosting state from the plurality of candidate rehosting states; and rehosting the microservice based application for implementation of the suitable rehosting state identified by the identifying.

In a further aspect, a system can be provided. The system can include, for example, a memory. In addition, the system can include one or more processor in communication with the memory. Further, the system can include program instructions executable by the one or more processor via the memory to perform a method. The method can include, for example: establishing, for a microservice defining a microservice based application hosted in a source state, edge characterizing data that characterizes a relationship of the microservice to respective ones of remaining microservices defining the microservice based application, wherein the establishing is performed in dependence on observatory data obtained for the microservice based application hosted in the source state; repeating the establishing for second to Nth microservices defining the microservice based application, and outputting from the repeating an application characterizing dataset that characterizes the microservice based application hosted in the source state; generating a plurality of candidate rehosting states for the microservice based application; for respective ones of the candidate rehosting states, producing a candidate application characterizing dataset; identifying, in dependence on the producing, a suitable rehosting state from the plurality of candidate rehosting states; and rehosting the microservice based application for implementation of the suitable rehosting state identified by the identifying.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having an orchestrator, computer environments, and user equipment (UE) devices according to one embodiment;

FIG. 2 is an infrastructure schematic view of the system of FIG. 1 according to one embodiment;

FIG. 3 is a flowchart illustrating a method for performance by a manager system interoperating with computer environments and UE devices according to one embodiment;

FIG. 4 depicts a predictive model trained by machine learning according to one embodiment;

FIG. 5 is a flowchart illustrating a method for performance by a system according to one embodiment;

FIG. 6 is a schematic diagram illustrating a source state for a microservice based application according to one embodiment;

FIG. 7 is a schematic diagram illustrating a target state for a microservice based application according to one embodiment;

FIG. 8 depicts an artificial neural network (ANN) according to one embodiment;

FIG. 9 depicts a computing environment according to one embodiment.

### DETAILED DESCRIPTION

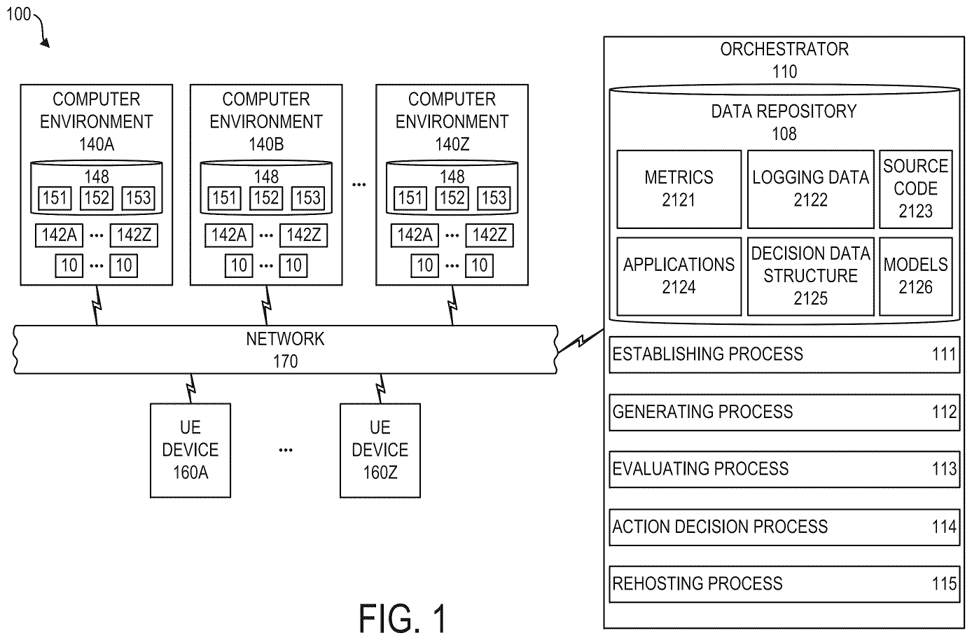

System 100 for use in optimizing microservice based applications is shown in FIG. 1. System 100 can include orchestrator 110 having an associated data repository 108, computer environments 140A-140Z and UE devices 160A-160Z. Orchestrator 110 computer environments 140A-140Z and UE devices 160A-160Z can be computing node-based systems that are in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

Orchestrator 110 can be external to computer environments 140A-140Z or can be co-located with one or more computer environment of computer environments 140A-140Z. Computer environments 140A-140Z can be provided by any type of computer environment, e.g., a data center, e.g., a data network data center, edge data center, a local area network (LAN), a single computing node, and the like.

Respective one of one's of computer environments 140A-140Z can include one or more computing node 10, data sources 142A-142Z and data storage repository 148. Data sources 142A-142Z can define sources of logging data defined by log messages and/or sources of metrics messages defined by metrics data messages. Data sources 142A-142Z can comprise e.g., logging agents of applications, which produce application log messages, logging agents of operating systems which include system log messages, logging agents which produce security log messages, logging agents which produce audit log messages, logging agents which produce transaction log messages, and logging agents which produce event log messages. Data sources 142A-142Z can comprise e.g., metrics generating agents producing various types of metrics data. IT metrics data can be various measurable indicators used to evaluate the performance, security, infrastructure, and user experience of IT systems. Key performance metrics can include system uptime, response time, throughput, and latency, all of which can help assess the operational efficiency of IT systems. Security metrics can focus on incident response time, the number of vulnerabilities, patch management, and intrusion detection rate, ensuring system security can be maintained. Application metrics, such as error rate, crash frequency, load time, and concurrent users, can track the reliability and performance of software applications. Infrastructure metrics can monitor the health of IT resources through measures like CPU utilization, memory usage, network bandwidth, and disk I/O. Service-level metrics, like mean time to resolution (MTTR), mean time between failures (MTBF), and service desk resolution times, can measure the efficiency of IT service delivery. Lastly, user experience metrics, like satisfaction rate, first call resolution, and system availability, can gauge how well IT services meet user expectations and demands. Together, these metrics can help organizations optimize their IT systems, improve service quality, and ensure security and efficiency.

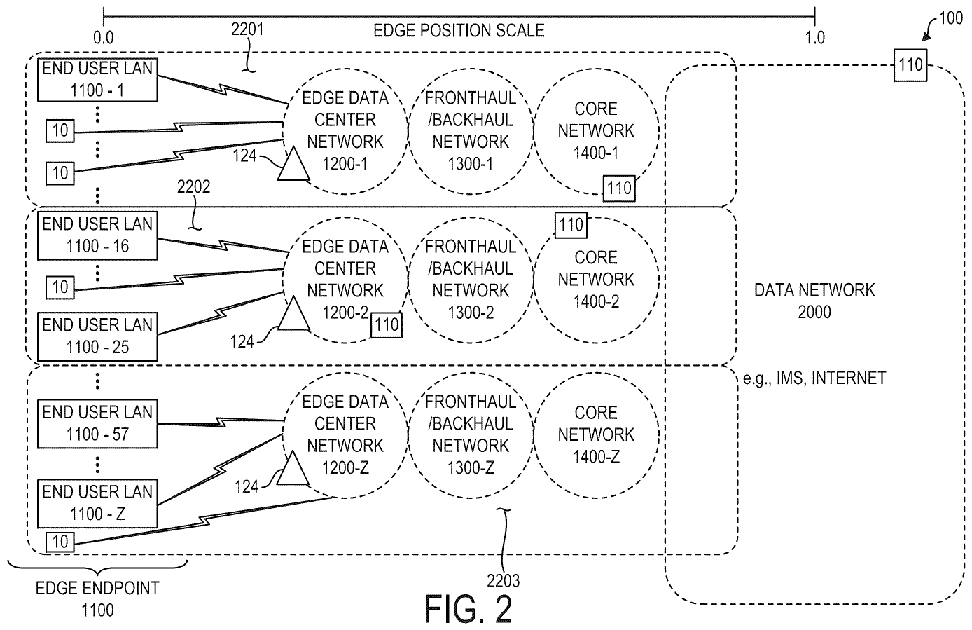

FIG. 2 depicts a physical network implementation view of system 100. System 100, as set forth herein, including in reference to FIG. 1 and FIG. 2, can be compliant with Fifth Generation (5G) or later technologies according to one embodiment. Respective edge enterprise entity networks can include edge infrastructure owned, operated, and/or controlled by one or more edge enterprise entity distributed throughout different geospatial regions within a geospatial area.

In one embodiment, a certain edge enterprise entity can own, operate, and/or control the edge network infrastructure comprising edge data center network 1200-1, fronthaul/backhaul network 1300-1, and core network 1400-1 in a first geospatial region 2201. The certain edge enterprise can own, operate, and/or control the edge infrastructure comprising edge data center network 1200-2, fronthaul/backhaul network 1300-2, and core network 1400-2 on a second geospatial region 2202. The certain edge enterprise entity can own, operate, and/or control the edge infrastructure comprising edge data center network 1200-Z, fronthaul/backhaul network 1300-Z, and core network 1400-Z in a third geospatial region 2203. In another example, the different instances of edge enterprise entity infrastructure 1000 can be owned, operated, and/or controlled by different edge enterprise entities. Different respective ones of the edge enterprise entities can be telecommunications network providers which are sometimes referred to as communication service providers (edge enterprise entity CSPs). Each edge data center network 1200-1 to 1200-Z, each fronthaul/backhaul network 1300-1 to 1300-Z and each core network 1400-1 to 1400-Z of FIG. 2 can define a different computer environment of computer environments 140A-140Z (FIG. 1).

Embodiments herein recognize that hosting service functions defined by microservices on one or more computing node within an edge enterprise entity infrastructure 1000 can provide various advantages including latency advantages for speed of service delivery to one or more computing node 10 defining an end user computing node at edge endpoint 1100.

At edge endpoint 1100 there can be disposed computing nodes 10, e.g., either standalone computing nodes, or computing nodes 10 disposed within end user LANs 1100-1 to 1100-Z. Each standalone computing node 10 defining an end user computing node and each LAN of LANs 1100-1 to 1100-Z can define a different computer environment of computer environments 140A-140Z.

Each edge data center network of edge data center networks 1200-1 to 1200-Z can have an associated base station 124 and can be in communication, via base station 124, with one or more computer environment of edge endpoint 1100 within its geographical region.

Data network 2000 can include, e.g., an IP multimedia sub-system (IMS) and/or “the internet” which can be regarded as the network of networks that consist of private, public, academic, business, and government networks of local to global scope linked by a broad array of electronic, wireless, and optical networking technologies. Data network 2000 can include, e.g., a plurality of non-edge data network data centers. Such data centers can define computer environments of computer environments 140A-140Z and can include private enterprise data centers as well as multi-tenancy data centers provided by IT enterprises that provide for hosting of service functions developed by a plurality of different enterprise entities.

Orchestrator 110, in one embodiment, can be disposed in data network 2000. In one embodiment, orchestrator 110 can be iteratively replicated from data network 2000 into respective ones of core networks 1400-1, 1400-2, and 1400-Z. Alternatively or additionally, instances of orchestrator 110 can be disposed in and collocated with another computer environment of system 100.

Data storage repository 148 can include metrics data storage area 151, logging data storage area 152 and source code repository 153. Logging data can include, e.g., the described logging data that can be output by data sources 142A-142Z. Data repository in metrics volume 2122 can store metrics data. Metrics data can include, e.g., the described metrics data that can be output by data sources 142A-142Z. Stored logging data and stored metrics data can be timestamped to specify the time of initial obtaining of the logging data and/or metrics data.

UE devices 160A-160Z can be provided by UE devices associated to administrator users who are agents of enterprises having applications orchestrated by orchestrator 110.

Data repository 108 of orchestrator 110 can store various data. Data repository 108 in metrics data area 2121 can store metrics data received from computer environments 140A-140Z. Data repository 108 in metrics volume 2122 can store metrics data. Metrics data can include, e.g., the described metrics data that can be output by data sources 142A-142Z. Data repository 108 in logging data area 2122 can store logging data received from computer environments 140A-140Z. Logging data can include, e.g., the described logging data that can be output by data sources 142A-142Z of computer environments 140A-140Z. Stored logging data and stored metrics data can be timestamped to specify the initial time of obtaining of the logging data and/or metrics data.

Data repository 108 in source code repository 2123 can store source code received from computer environments 140A-140Z. The source code can include source code defining microservices of microservice based applications being orchestrated by orchestrator 110.

Data repository 108 in applications area 2124 can store data on applications being hosted within system 100, including information on hosting requirements for such applications, e.g., as determined from processing service level agreement documents from natural language processing, historical hosting configurations, current hosting configurations and the like.

Data repository 108 in decision data structure area 2125 can store decision data structures for use in return of action decisions by orchestrator 110. Data repository 108 in models area 2126 can store trained predictive models for use in return of action decisions by orchestrator 110.

In its operation, orchestrator 110 can orchestrate the hosting of microservice based applications hosted within system 100. Orchestrator 110 can run various processes. Orchestrator 110 running establishing process 111 can include orchestrator 110 examining observatory data and/or source code data for return of characterizing data that characterizes between microservices defining an application.

In one example, a pair of microservices can be directly dependent on one another, e.g., can be directly connected. In another example, services microservices can be indirectly dependent on another, e.g. microservices can be connected to one another indirectly. In another example, a pair of microservices can be independent of one another.

Orchestrator 110 running establishing process 111 can include orchestrator 110 examining one or more of metrics data, logging data and/or source code data for establishing characterizing data provided by proximity data that specifies characteristics of relationships between respective microservices defining an application.

Orchestrator 110 running generating process 112 can include orchestrator 110 generating candidate rehosting states for a microservices based application. Orchestrator 110 running generating process 112 can include orchestrator 110 biasing the generation of candidate target rehosting states in favor of rehosting states having a predetermined characteristics. The biasing can be in dependence on edge characterizing data of certain first and second microservices in a current source state satisfying one or more criterion.

Orchestrator 110 running evaluating process 113 can include orchestrator 110 evaluating candidate rehosting states for selection of rehosting state for implementation. Orchestrator 110 running evaluating process 113 can include orchestrator 110 establishing edge characterizing data in dependence on predicted observatory data.

Orchestrator 110 running action decision process 114 can include orchestrator 110 returning an action decision in dependence on a result data output by orchestrator 110 running evaluating process 113. In one embodiment, orchestrator 110 running action decision process 114 can include orchestrator 110 outputting an action decision that specifies that a microservices based application is to be re-hosted according to a selected rehosting state amongst generated candidate rehosting candidate states.

Orchestrator 110 running re-hosting process 113 can include orchestrator 110 re-hosting one or more microservice defining a microservices based application. Orchestrator 110 running re-hosting process 113 can include orchestrator 110 re-hosting one or more microservice defining a microservices based application according to a selected rehosting state amongst generated candidate rehosting candidate states.

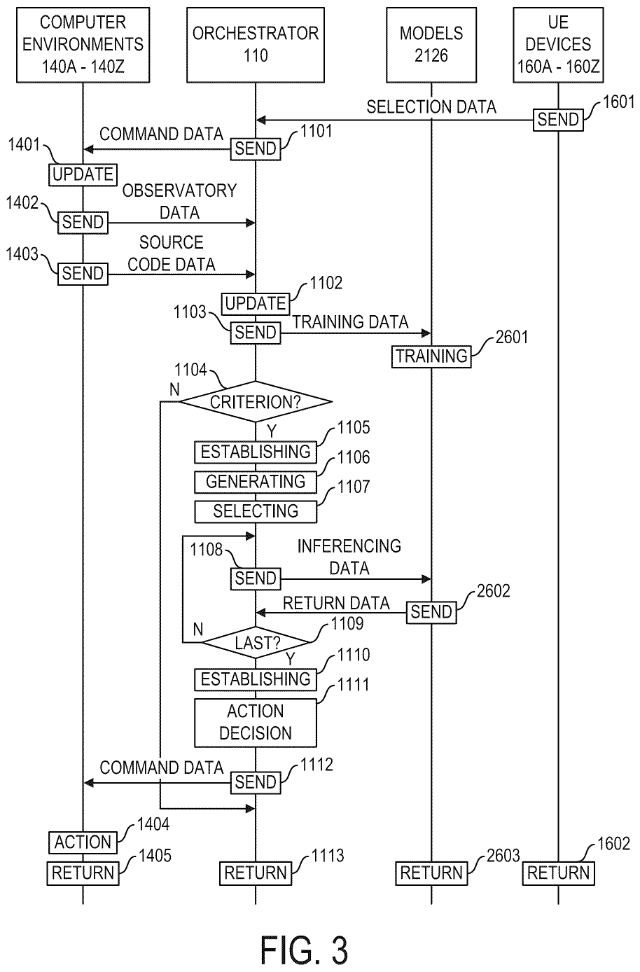

A method for performance by orchestrator 110 interoperating with computer environments 140A-140Z models of models area 2126 and UE devices 160A-160Z is set forth in reference to the flowchart of FIG. 3.

At send block 1601, UE devices 160A-160Z can be sending selection data. The selection data sent at send block 1601 can be administrator user defined selection data. Administrator users of system 100 can include, e.g., administrator users of orchestrator 110 and/or respective ones of computer environments 140A-140Z. Selection data sent at send block 1601 can include request data requesting that a certain application be subject to orchestration by orchestrator 110. Selection data sent at send block 1601 can include selection data that defines one or more attribute of a microservice based application. The selection data can specify microservices names mapping to roles of microservices defining an application. The selection data can include, e.g., administrator user defined selection data that specifies, e.g., a certain microservice based application has been deployed, modified, or decommissioned.

Selection data sent at send block 1601 can include, e.g., administrator user defined selection data that specifies, e.g., that a certain microservice based application has been deployed, modified, or decommissioned.

On completion of selection data sent at block 1601, orchestrator 110 can proceed to send block 1101. At send block 1101, orchestrator 110 can send command data for receipt by computer environments 140A-140Z. The command data can include command data commanding computer environments 140A-140Z to send appropriate observatory data and source code data defining an application being serviced and supported by orchestrator 110 based on the selection data received at the most recent iteration of send block 1601 and based on the most recent update data derived at the most recent iteration of update block 1102.

On receipt of the selection data sent at block 1601, orchestrator 110 at send block 1101 can send command data for receipt by computer environments 140A-140Z. The command data sent at send block 1101 can include command data commanding computer environments 140A-140Z to send appropriate observatory data and source code data defining an application being serviced and supported by orchestrator 110. On receipt of the command data sent at block 1101, computer environments 140A-140Z can perform updating at update block 1401 to update control data according to the received command data to update the delivery of observatory data and/or source code data by computer environments 140A-140Z to orchestrator 110 at the next iteration of send block 1402 and send block 1403.

On completion of update block 1401, computer environments 140A-140Z can proceed to send block 1402 and send block 1403.

At send block 1402, computer environments 140A-140Z can be sending observatory data for receipt by orchestrator 110 based on the most recently updated command data updated at update block 1401. The observatory data sent at send block 1402 can include, e.g., metrics data and/or logging data. Computer environments 140A-140Z sending the observatory data at send block 1402 can be sending, e.g., live current observatory data from data sources 142A-142Z timestamped to specify the current time and/or can be sending historical observatory data from data stored in data repository 108 timestamped to specify a time of original generation of such observatory data.

At send block 1403, computer environments 140A-140Z can be sending source code data for receipt by orchestrator 110 based on the most recently updated command data updated at update block 1401. The source code data can be stored in data repository 153 of the respective computer environments 140A-140Z. The source code data can be source code data that defines source code of one or more microservice defining an application hosted on a computer environment of computer environments 140A-140Z.

Orchestrator 110, responsively to the receipt of the observatory data sent at send block 1402, the source code data sent at send block 1403 and the selection data sent at block 1601 can store the received observatory data, source code data and/or selection data at update block 1102. At update block 1102, orchestrator 110 can store the received data into an appropriate one of metrics data area 2121, logging data area 2122, or source code repository 2123 of data repository 108.

On completion of update block 1102, orchestrator 110 can proceed to send block 1103. At send block 1103, orchestrator 110 can send training data from data repository 108 for training of machine learning predictive models of models area 2126. Machine learning predictive models of models area 2126 can be trained to learn behavior of microservice based applications based on hosting attributes of the microservices defining the applications and corresponding observatory data collected based on those hosting attributes.

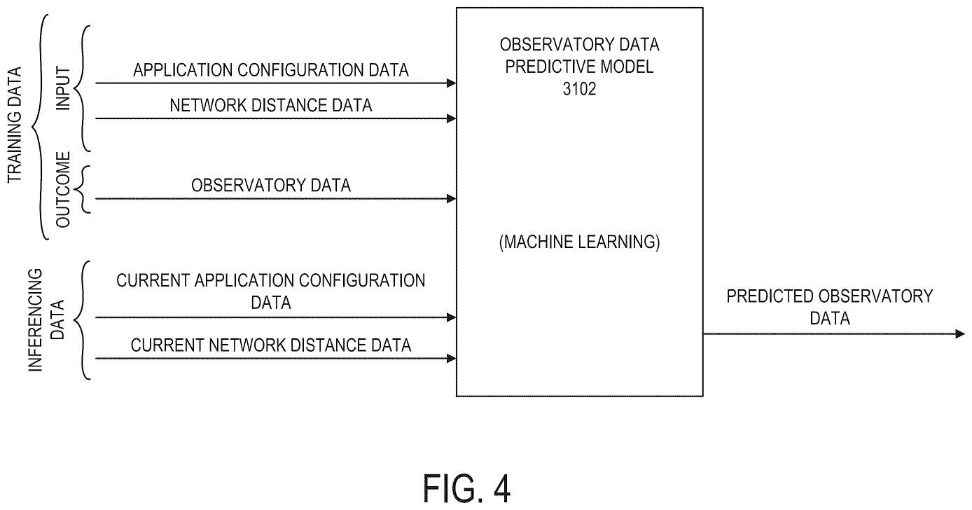

On receipt of the described training data sent at send block 1103, machine learning predictive models of models area 2126 can be trained at training block 2601 in a manner set forth in reference to observatory data of predictive model 3102 as set forth in FIG. 4.

Observatory data predictive model 3102 can be trained with iterations of training data. Iterations of training data for training observatory data predictive model 3102 can include as input training data, application configuration data, and network distance data for a particular application. At training block 2601, orchestrator 110 can be training multiple instances of observatory data predictive model 3102 and there can be provided an instance of observatory data predictive model 3102 for each respective application being serviced by orchestrator 110.

Outcome training data for training observatory data predictive model 3102 can include observatory data including the observatory data sent at send block 1402 and updated into data repository 108 at update block 1102 and can include as input training data application configuration data and network distance data.

Application configuration data can include, e.g., the set of microservice roles (names) defining an application generating the observatory data. Application configuration data can also include pair level data as set forth herein, e.g., set to the value of one or zero, as set forth in Table B.

Network distance data can include a dataset which, for each microservice defining a certain application, specifies a network distance of the microservice to each other microservice defining the certain application. Network distance data parameter value are set forth herein more fully in reference to Table C.

In one aspect, microservices hosted on a common machine, the common OS can be assigned a network distance of zero and for services hosted on disparate date data centers at different geospatial regions can be assigned a network distance of five.

Trained as described, observatory data predictive model 3102 can learn a relationship between application configuration data, network distance data, and observatory data. Once trained, observatory data predictive model 3102 can return a prediction as to observatory data based on application configuration data and known network distance data. Inferencing data for inferencing observatory data predictive model 3102, once trained, can include current application data for current application for which a prediction as to observatory data is desired and current network distance data, specifying network distances between microservices defining such application referenced in the inferencing data. Inferenced with inferencing dataset as described, observatory data predictive model 3102 can output predicted observatory data for an application configuration specified in the application configuration data referenced by the inferencing data.

In one embodiment, orchestrator 110 can be providing application hosting services to multiple enterprises and can be orchestrating contemporaneously, e.g., tens, hundreds or thousands or more applications.

On completion of send block 1103 for sending training data, orchestrator 110 can proceed to criterion block 1104. At criterion block 1104, orchestrator 110 can ascertain whether a criterion for rehosting an application has been satisfied. At criterion block 1104, orchestrator 110 can ascertain whether a criterion has been satisfied for evaluating prospective rehosting of one or more microservice defining an application being serviced and supported by orchestrator 110. The criterion can include, e.g., that a performance parameter value specifying performance of an application has fallen below a threshold level of performance. In another example, the criterion can be that the current time matches the scheduled time for evaluating of rehosting.

On determining that the described criterion has not been satisfied, orchestrator 110 can bypass blocks 1105-1112 can proceed to return block 1113.

On the determination at criterion block 1104 that a criterion for rehosting has been satisfied, orchestrator 110 can proceed to establishing block 1105. At establishing block 1105, orchestrator 110 can perform examining of observatory data of the application triggering the satisfaction of criterion block 1104. For output of microservices characterizing data that characterizes microservices defining the application orchestrator 110 at establishing block 1105 can output application characterizing data as set forth in Table A hereinbelow.

Establishing at block 1105 can include establishing microservices characterizing data in dependence on observatory data sent at send block 1402 for the current application triggering the satisfaction of criterion at criterion block 1104 can further include establishing microservices characterizing data based on user-specified data.

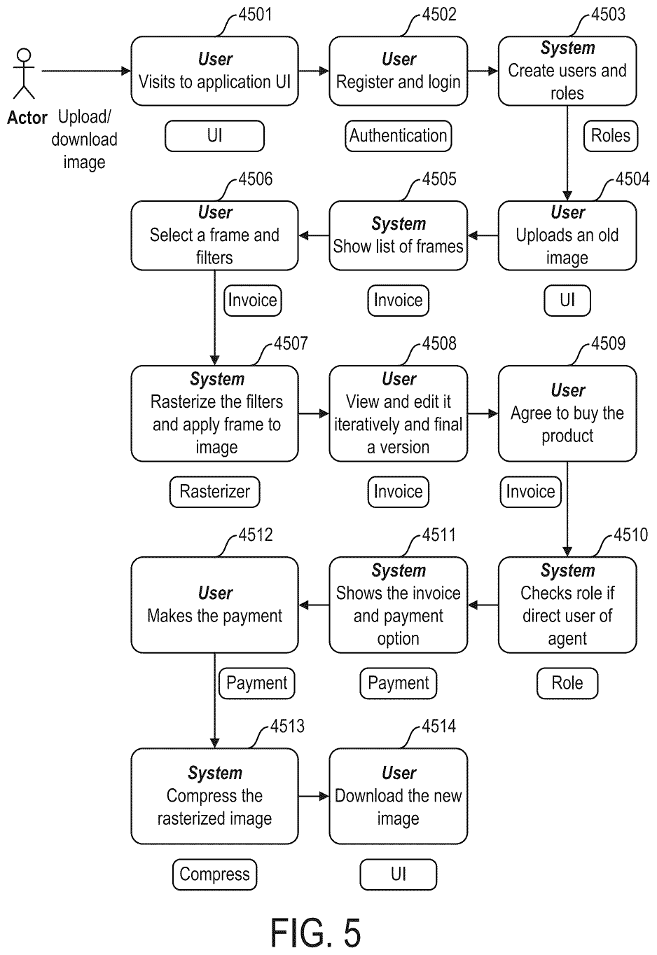

In FIG. 5, there is set forth a schematic flow diagram view of an application defined by multiple microservices. Microservices defining the application of FIG. 5 can include a user interface (UI) microservice, an authentication microservice, a roles microservice, an invoice microservice, a rasterizer microservice, a payment microservice, and a compression microservice.

The application depicted in FIG. 5 can be an application for beautification of a scanned photo. At block 4501 a user via operation of the user interface microservice visits an application user interface. At block 4502, by operation of the authentication microservice, registration and login is performed. At block 4503, the system, by operation of the roles microservice, can create users and roles. At block 4504, the user, by operation of the user interface microservice, can upload an old image. At block 4505, the system, by operation of the invoice microservice can show a list of frames. At block 4506, the user, by operation of the invoice microservice can select a frame and filters. At block 4507, the system, by the rasterizer microservice, can rasterize the filters and apply frame to an image. At block 4508, the user, by operation of the invoice microservice can view and edit an image. At block 4509, the user, by operation of the invoice microservice, can agree to buy the product. At block 4510, the system by operation of the role microservice can check roles to determine whether the user is the direct user of an agent. At block 4511, the system, by operation of the payment microservice, can show the invoice and payment option. At block 4512, the user, by operation of the payment microservice can make a payment. At block 4513, the system, by operation of the compression microservice can compress the rasterized image. At block 4514, the user by operation of the user interface microservice can download the new image.

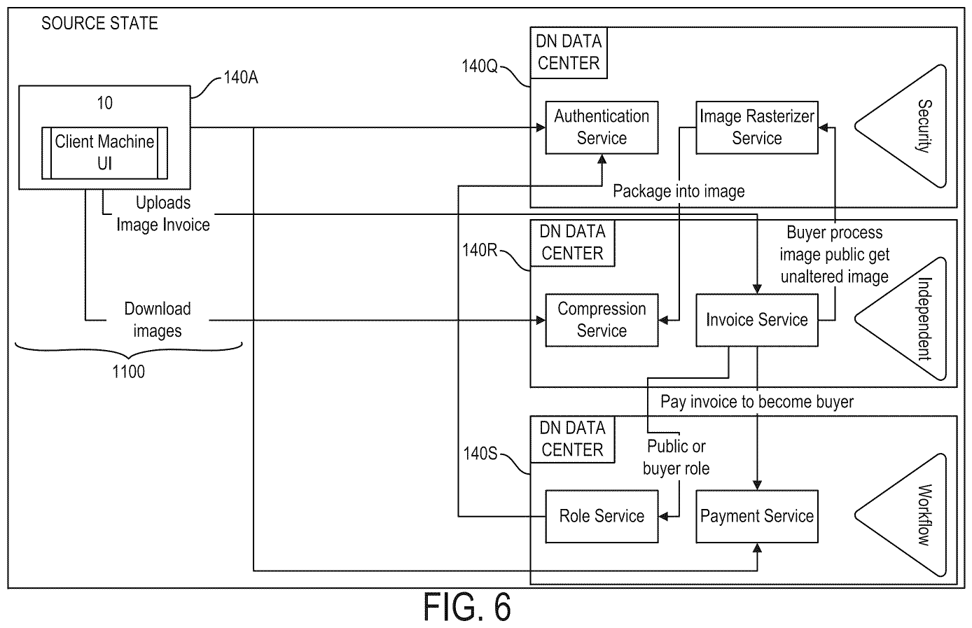

FIG. 6 depicts a source hosting state view of a microservices-based application of FIG. 5. As shown in FIG. 6 the application depicted in FIG. 5 subject to orchestration servicing can include the user interface (UI) microservice hosted on a client machine defined by a computing node 10 at an edge endpoint 1100, the authentication microservice hosted on data network data center 140Q, the roles microservice hosted on data network data center 140S, the invoice microservice hosted on data network data center 140R, the rasterizer microservice hosted on data network data center 140Q, the payment microservice hosted on data network data center 140S, and the compression microservice hosted on data network data center 140R.

At establishing block 1105, orchestrator 110 can establish application characterizing data for characterizing a microservices-based application, such as the microservices based application set forth in reference to FIG. 5 and FIG. 6. A partial view of application characterizing data is set forth herein in Table A. Table A sets forth an example of application characterizing data for the microservices-based application set forth in reference to FIG. 5 and FIG. 6 wherein Cloud1 maps to data network data center 140Q, Cloud2 maps to data network data center 140R, and Cloud3 maps to data network data center 140S.

TABLE A

| | | | | | Network |
|---|---|---|---|---|---|
| Microservice | Data | Microservice | Data | Pair | Dis- |
| i | Center | j | Center | Level* | tance** |
| UI | Client | Authentication | Cloud1 | 1 | 5 |
| UI | Client | Role Service | Cloud3 | 0 | 0 |
| UI | Client | Invoice | Cloud2 | 1 | 5 |
| UI | Client | Payment | Cloud3 | 1 | 5 |
| UI | Client | Rasterizer | Cloud1 | 0 | 0 |
| UI | Client | Compression | Cloud2 | 1 | 5 |
| Authentication | Cloud1 | Authentication | Cloud1 | −1 | 0 |
| Authentication | Cloud1 | Role Service | Cloud3 | 1 | 5 |
| Authentication | Cloud1 | Invoice | Cloud2 | 0 | 0 |
| Authentication | Cloud1 | Payment | Cloud3 | 0 | 0 |
| Authentication | Cloud1 | Rasterizer | Cloud1 | 0 | 0 |
| Authentication | Cloud1 | Compression | Cloud2 | 0 | 0 |
| Role Service | Cloud3 | Authentication | Cloud1 | 1 | 5 |
| Role Service | Cloud3 | Role Service | Cloud3 | −1 | 0 |
| Role Service | Cloud3 | Invoice | Cloud2 | 1 | 5 |
| Role Service | Cloud3 | Payment | Cloud3 | 0 | 0 |
| Role Service | Cloud3 | Rasterizer | Cloud1 | 0 | 0 |
| Role Service | Cloud3 | Compression | Cloud2 | 0 | 0 |
| Invoice | Cloud2 | Authentication | Cloud1 | 0 | 0 |
| Invoice | Cloud2 | Role Service | Cloud3 | 1 | 5 |
| Invoice | Cloud2 | Invoice | Cloud2 | −1 | 0 |
| Invoice | Cloud2 | Payment | Cloud3 | 1 | 5 |
| Invoice | Cloud2 | Rasterizer | Cloud1 | 1 | 5 |
| Invoice | Cloud2 | Compression | Cloud2 | 0 | 0 |
| Payment | Cloud3 | Authentication | Cloud1 | 0 | 0 |
| Payment | Cloud3 | Role Service | Cloud3 | 0 | 0 |
| Payment | Cloud3 | Invoice | Cloud2 | 1 | 5 |
| Payment | Cloud3 | Payment | Cloud3 | −1 | 0 |
| Payment | Cloud3 | Rasterizer | Cloud1 | 0 | 0 |
| Payment | Cloud3 | Compression | Cloud2 | 0 | 0 |
| Rasterizer | Cloud1 | Authentication | Cloud1 | 0 | 0 |
| Rasterizer | Cloud1 | Role Service | Cloud3 | 0 | 0 |
| Rasterizer | Cloud1 | Invoice | Cloud2 | 1 | 5 |
| Rasterizer | Cloud1 | Payment | Cloud3 | 0 | 0 |
| Rasterizer | Cloud1 | Rasterizer | Cloud1 | −1 | 0 |
| Rasterizer | Cloud1 | Compression | Cloud2 | 1 | 5 |
| Compression | Cloud2 | Authentication | Cloud1 | 0 | 0 |
| Compression | Cloud2 | Role Service | Cloud3 | 0 | 0 |
| Compression | Cloud2 | Invoice | Cloud2 | 0 | 0 |
| Compression | Cloud2 | Payment | Cloud3 | 0 | 0 |
| Compression | Cloud2 | Rasterizer | Cloud1 | 1 | 5 |
| Compression | Cloud2 | Compression | Cloud2 | −1 | 0 |

As set forth in Table A, application characterizing data can include edge characterizing data that can characterize for each respective given microservice defining an application, a relationship between the given microservice defining the application and each remaining microservice defining the application. An edge of a certain microservice of a microservices-based application herein can refer to the relationship of that microservice to one other microservice of the microservices-based application. Each microservice can have a number of edges equal to the number of microservices defining the application minus 1.

The application characterizing data of Table A includes edge characterizing data that characterizes a relationship between a given microservice and respective remaining microservices of an application. For example, in reference to Table A there is set forth, e.g., in reference to the authentication microservice edge characterizing relationship data of the authentication microservice to the role microservice, the invoice microservice, the payment input microservice, the rasterizer microservice, and the compression microservice.

Edge characterizing data referenced in Table A can include a “pair level” parameter value and a “network distance” parameter value. Orchestrator 110 can assign the “pair level” parameter value according to the rules as are summarized in Table B.

TABLE B

| | | | “Pair level” parameter |
|---|---|---|---|
| Row | Characteristic of pairing | Disposition | value |
| 1 | Outlier (microservice | N/A | −1 |
| | pairing to itself) | | |
| 2 | These microservices are | Independent | 0 |
| | not connected to one | microservice | |
| | another | | |
| 3 | These microservices are | Dependent | 1 |
| | connected to one another | microservice | |

Orchestrator 110 can assign the “pair level” parameter value based on selected data designated by an administrator user, e.g., with the selection data sent by the user at send block 1601 as entered with use of a user interface presented to the user. Orchestrator 110 alternatively or additionally can assign the “pair level” parameter value based on analysis of observatory data. To determine whether two microservices are independent or indirectly dependent, orchestrator 110 can perform an analysis of logs, metrics, and/or tracing data. Independence can be confirmed if there is no evidence of shared communication, such as API calls, gRPC interactions, or message exchanges, and if the services rely on distinct data sources without overlapping request or transaction IDs in logs. Metrics indicating independence include uncorrelated resource usage (CPU, memory, or network), unrelated traffic patterns, and unaffected availability metrics, with failures in one service having no impact on the other. Conversely, indirect dependency is revealed through shared identifiers, such as trace or correlation IDs, and logs showing chained errors or timestamped patterns indicating a cause-and-effect relationship. Metrics like correlated latency, traffic spikes, or performance degradation in one service impacting another are key indicators, as are shared dependencies on databases, caches, or message brokers, where resource usage patterns overlap. Distributed tracing tools, such as Jaeger or Zipkin, can identify parent-child span relationships or shared trace pathways, indicating direct or indirect communication. Service mesh observability tools, like Istio, can also expose traffic flows or intermediary dependencies. Investigating middleware or load balancer logs can further clarify whether the two services rely on shared infrastructure. Tools such as Prometheus, Elasticsearch, Fluentd, and OpenTelemetry can be employed for gathering and analyzing data, highlighting dependencies and resource interactions. By examining these signals holistically, orchestrator 110 can determine whether microservices are fully independent or whether indirect dependencies exist through shared resources, intermediary services, or correlated workflows.

In regard to values of Table B which contain 0 to specify independent microservices, orchestrator 110 can preferentially recommend such microservices for rehosting at client locations of one or more edge endpoint 1100 (FIG. 2).

In regard to values of Table B which contain 1 to specify dependent microservices having at least some level of dependency, orchestrator 110 can preferentially recommend rehosting in a manner dependent on determined edge characterizing parameter values set forth herein, in the form of proximity parameter values.

Orchestrator 110 can assign the “network distance” parameter value according to the rules as set forth herein in Table C.

TABLE C

| | Hosting characteristic of | |
|---|---|---|
| Row | pair of microservices | Network distance parameter value |
| 1 | Same computing node | 0 |
| | with same OS core | |
| 2 | Same computing node | 1 |
| | with virtual OS | |
| 3 | Different computing | 2 |
| | nodes sharing same | |
| | storage network | |
| 4 | Different computing | 3 |
| | nodes sharing same local | |
| | area network | |
| 5 | Different computing | 4 |
| | nodes in same | |
| | geographical region | |
| 6 | Different computing | 5 |
| | nodes in different | |
| | geographical regions | |

According to Table C, orchestrator 110 can assign the value of network distance “0” where a pair of microservices hosted on the same machine with the same OS core can assign the value 1, where a pair of microservices share a machine with the virtual OS can assign the network distance value 2, where pair of microservices are hosted on different machines, but share a common storage network can assign the network distance 3, where a pair of microservices are hosted on different machines but in the same local network can assign the network distance value 4, where a pair of microservices are on different machines but in the same geographical zone and can assign the scoring value network distance value 5 when the first and second microservices are hosted on different machines and in different geographical regions.

Orchestrator 110 at establishing block 1105 can establish characterizing data for each microservice edge in the form of a proximity score for each edge. Orchestrator 110 can determine a proximity score for each edge of each microservice defining an application according to Eq. 1.

$${P}_{ij} = Pair {level}_{ij} * ( ( \frac{I {F}_{ij} * L {S}_{ij}}{{F}_{ij}} * N {D}_{ij} ) - S D {D}_{ij} * {Security}_{ij} ) \qquad ( Eq . 1 )$$

Where Pᵢⱼ refers to Proximity score between Microservice i and Microservice j, where Pair levelᵢⱼ refers to whether Microservice i and Microservice j are connected directly or indirectly to each other as described in Table B, where IFᵢⱼ refers to Interaction Frequency of requests between Microservice i and Microservice j, where LSᵢⱼ refers to Latency Sensitivity (LS) between Microservice i and Microservice j, where NDᵢⱼ refers to Network distance between Microservice i and Microservice j as described in connection with Table C, where SDDᵢⱼ refers to a Shared Data dependency factor between Microservice i and Microservice j, and wherein Securityᵢⱼ refers to security dependencies between Microservice i and Microservice j.

Orchestrator 110 to calculate Interaction Frequency between Microservice i and Microservice j can employ Eq. 2 as follows.

$$I {F}_{ij} = \frac{{\sum }_{t = 1}^{T} {C}_{ij} ( t )}{T} \qquad ( Eq . 2 )$$

Where: IFᵢⱼ: Interaction Frequency of requests between Microservice i and Microservice j, where Cᵢⱼ(t): Number of calls or interactions between Microservice i and Microservice j at time t, and where T is the Total observation period (e.g., in seconds, minutes, or hours).

Orchestrator 110 to calculate Latency Sensitivity between Microservice i and Microservice j can employ Eq. 3 as follows.

$$L {S}_{ij} = \frac{{R}_{ij}}{{M}_{Tolerance}} \qquad ( Eq . 3 )$$

Where LSᵢⱼ: Latency Sensitivity (LS) between Microservice i and Microservice j, where Rᵢⱼ: Required Latency (ms) between Microservice i and Microservice j, and where M_{Tolerance}: Maximum Acceptance Latency (ms) between Microservice i and Microservice j. Orchestrator 110 deriving latency sensitivity parameter values at establishing block 1105 can include orchestrator 110 processing service level agreement (SLA) data which can be sent at send block 1601 (with selection data) and/or send block 1402 (with observatory data).

Orchestrator 110 to calculate Shared Data dependency factor (SDD) between Microservice i and Microservice j can employ Eq. 4 as follows.

$$S D {D}_{ij} = \frac{{\sum }_{k ∈ Shared} {D}_{k}^{ij}}{{\sum }_{k ∈ All} {D}_{k}^{ij}} \qquad ( Eq . 4 )$$

Where SDDᵢⱼ is the shared Data dependency factor between Microservice i and Microservice j, where

$${D}_{k}^{ij}$$

is a Binary indicator showing if Microservices i and j have both access to shared resource k (1 if both access, 0 otherwise), where Shared is the set of data resources k that are shared by both Microservice i and Microservice j, and where the set of all unique data resources accessed by either Microservice i or j.

Orchestrator 110 to calculate security dependency, Securityᵢⱼ between Microservice i and Microservice j can employ the decision data structure of Table D.

TABLE D

| | Hosting characteristic of | |
|---|---|---|
| Row | pair of microservices | Security parameter value |
| 1 | Microservice i and | 1 |
| | Microservice j are hosted | |
| | on the same network | |
| 2 | Microservice i and | 2 |
| | Microservice j are hosted | |
| | on different networks | |

As seen in Eq. 1 orchestrators 110 can calculate Proximity scores for each microservice in relation to each remaining microservice based on the relationships between microservices, capturing their interaction frequency, data dependencies, latency requirements, network distance and security context. Orchestrator 110 can employ proximity scores to: Quantify the relationship between two microservices (edge-based scoring), and evaluate multiple microservices together to determine cluster dependencies, Identify independence for re-hosting decisions.

As set forth in reference to Eq. 1, orchestrator 110 can calculate proximity score. Orchestrator 110 can calculate proximity score between two microservices using a weighted combination of pairing level, interaction frequency, latency sensitivity, shared data dependency, security context, and network distance.

Regarding interaction frequency (IF), interaction frequency measures the number of calls, messages, or data exchanges that occur per second between two microservices (i and j). It represents how often these microservices need to communicate to perform their functions effectively. For example, High interaction frequency indicates frequent communication between microservices, suggesting a strong dependency. To determine the number of calls, messages, or data exchanges per second between microservices, orchestrator 110 can use various logging and metrics data. HTTP/HTTPS access logs, such as those from NGINX or custom applications, provide timestamps, endpoints, and status codes to calculate requests per second. Application logs can also track service-specific events and message exchanges. If a message broker (e.g., Kafka or RabbitMQ) is used, its metrics, like messages sent/received per second or queue activity, are valuable. Distributed tracing tools like Jaeger or OpenTelemetry capture trace spans and timings, helping correlate and aggregate calls between services. Infrastructure monitoring systems (e.g., Prometheus, Datadog) offer request rate metrics or network traffic data for service-to-service interactions. Additionally, network traffic tools like Wireshark or service mesh metrics (e.g., Istio) can measure communication patterns directly. Backend database query logs or metrics may also reflect call activity if these interactions trigger database operations. Automated analysis can leverage tools like Elastic Stack for log aggregation, PromQL for metrics queries, or tracing frameworks for detailed insights. By combining logs, metrics, and tracing data, orchestrator 110 can accurately measure the frequency of interactions between microservices in real-time or over specific intervals.

Using IF, orchestrator 110 can identify microservices that can benefit from co-location due to frequent communication.

Regarding latency sensitivity (LS), latency sensitivity herein refers to how critical it is for a microservice's interactions (calls, data exchanges, or responses) to be performed within a specific, minimal time frame to maintain acceptable performance. It measures the tolerance of a microservice or its interactions to delays. For example, High latency sensitivity indicates that the microservice requires very low latency for its interactions to ensure functionality or user experience.

Orchestrator 110 can prioritize microservices for co-location or proximity-based deployment when latency is critical.

Regarding shared data dependency (SDD), shared data dependency (SDD) herein measures the degree to which two or more microservices rely on the same databases, storage systems, or datasets to perform their operations. It quantifies the overlap in the data access or storage requirements between microservices. For example, higher SDD indicates stronger interdependence due to shared data usage, whereas a lower SDD suggests lesser or no shared data usage. To determine whether first and second microservices rely on the same databases, storage systems, or datasets, orchestrator 110 can analyze logs and metrics from various sources. Database query logs and metrics, such as SQL statements, accessed tables, or query counts by service, can reveal shared data usage. Storage system logs, like those from S3 or HDFS, show file or bucket access patterns, indicating shared dependencies. Application logs may include connection details or dataset references specific to each service. Distributed tracing tools, such as Jaeger or OpenTelemetry, capture external dependencies and resource usage during transactions, helping identify overlaps. Network traffic logs and service mesh metrics highlight shared endpoints or traffic patterns between services and external resources. Observability metrics from tools like Prometheus or Datadog, such as database connections or storage operations, provide additional evidence of shared usage. Finally, access logs from shared resources record operations and can directly link both services to common databases, storage systems, or datasets.

Orchestrator 110 can identify microservices that can benefit from being co-located due to frequent shared data usage.

Regarding security context, security context refers to a quantifiable metric used in the proximity score calculation to represent the security-related overhead and dependencies between two microservices over a network. security context encapsulates factors such as authentication complexity, authorization mechanisms, data sensitivity, compliance requirements, and communication protocol security.

Regarding network distance, network distance as explained further in reference to Table C hereinabove refers to a measure of the physical or logical separation between two microservices in a distributed architecture. It quantifies factors such as the local network, LAN, WAN, internet VPN. A shorter network distance indicates closer proximity, enabling faster communication and lower overhead, while a longer network distance suggests higher communication costs and potential delays, reducing the proximity score and influencing decisions toward optimization or re-hosting.

In reference to Table C and Table D where orchestrator 110 can assign parameter values based on hosting conditions, orchestrator 110 at establishing block 1105 can determine that a pair of microservices are hosted on a common computing node by examining selection data with administrator raised flags sent at iteration of send block 1601 and/or by examining observatory data. To determine whether first and second microservices are hosted on the same computing node using logging data, orchestrator 110 can analyze host-specific metadata such as hostnames, IP addresses, or node IDs in service or infrastructure logs. Containerized environments (e.g., Kubernetes) provide additional metadata, including pod names, node names, or cluster details, which can reveal shared nodes. Infrastructure logs from cloud providers may include instance or node identifiers, while service mesh and load balancer logs often capture host-level information. System metrics tools like Prometheus or Datadog tag metrics with host details, enabling correlation. Timestamp and sequence analysis can also indicate synchronous activity from the same node. Log aggregation platforms like Elastic Stack or Splunk append metadata, such as source host or cluster identifiers, which can link the services to a shared node. By correlating these logs and metrics, orchestrator 110 can identify whether the microservices operate on the same physical or virtual computing node.

Orchestrator 110 at establishing block 1105 can determine whether first and second microservices are hosted in the same geographical region using logging data that includes metadata like IP addresses, region tags, or geolocation information. Logs from cloud providers (e.g., AWS CloudWatch, Azure Monitor) often specify region details, such as availability zone or data center location, which can be compared for both services. Service orchestration platforms (e.g., Kubernetes) may include region or zone identifiers in deployment metadata. Infrastructure logs or metrics tools like Prometheus or Datadog may also tag data with regional information or source IPs, which can be geolocated to specific regions. By extracting and matching these region-related details from logs, the system can confirm geographical proximity. Additionally, tracing tools like OpenTelemetry or Jaeger can track communication flows and include location-based metadata if configured. Cross-referencing these details provides a reliable way to determine whether the microservices are hosted in the same region.

In performing determinations set forth in connection with Eqs. 1-4 and Table C and Table D, orchestrator 110 can process observatory data in the manner described which data can be enriched using source code data. Creating an enriched metrics and logging observatory for a microservice based on source code extraction can include orchestrator 110 automating the discovery of observable patterns, instrumenting code for enhanced visibility, and dynamically correlating runtime behavior with source-level insights. Orchestrator 110 can perform static and dynamic analysis of the microservice's source code to identify logging statements, metrics collection points, error handling, and dependencies. Orchestrator 110 with use of static analysis tools can parse the codebase to extract existing logging patterns, structured log formats, and performance-sensitive operations, while dynamic tracing tools (e.g., eBPF, OpenTelemetry) monitor runtime execution to detect gaps in observability. Based on this extraction, orchestrator 110 can apply an enrichment layer automatically inserting enhanced logging (e.g., structured JSON logs, trace IDs, contextual metadata) and exposing additional metrics (e.g., request latency, error rates, dependency health).

With use of Eqs. 1-4, and the decision data structures of Table C and Table D, orchestrator 110 at establishing block 1105 can establish application characterizing data as is set forth in Table E for the example microservices based application in the source state as is shown in FIG. 6.

TABLE E

| | | | | | | | | | | | THRESHOLD = |
|---|---|---|---|---|---|---|---|---|---|---|---|
| Parameters | | | | | | | | | | | 2.5 |
| Micro- | Data | Micro- | Data | Pair | Network | Interaction | Latency | Data | Security | Proximity | Score |
| service i | Center | service j | Center | Level | Distance | Frequency | (ms) | Sharing | Context | Score | Decision |
| UI | Client | Authen- | Cloud1 | 1 | 5 | 100 | 4 | 1 | 2 | 3.29 | Relocate |
| | | tication | | | | | | | | | if |
| | | | | | | | | | | | Possible |
| UI | Client | Role | Cloud3 | 0 | 0 | 0 | 0 | 0 | 2 | 0 | Independent- |
| | | Service | | | | | | | | | No |
| | | | | | | | | | | | Impact |
| UI | Client | Invoice | Cloud2 | 1 | 5 | 100 | 3 | 1 | 2 | 2.44 | Keep as |
| | | | | | | | | | | | is-No |
| | | | | | | | | | | | decision |
| UI | Client | Payment | Cloud3 | 1 | 5 | 50 | 3 | 1 | 2 | 1.17 | Keep as |
| | | | | | | | | | | | is-No |
| | | | | | | | | | | | decision |
| UI | Client | Rasterizer | Cloud1 | 0 | 0 | 0 | 0 | 0 | 2 | 0 | Independent- |
| | | | | | | | | | | | No |
| | | | | | | | | | | | Impact |
| UI | Client | Com- | Cloud2 | 1 | 5 | 120 | 7 | 2 | 2 | 6.93 | Relocate |
| | | pression | | | | | | | | | if |
| | | | | | | | | | | | Possible |
| Authen- | Cloud1 | Authen- | Cloud1 | −1 | 0 | 0 | 0 | 0 | 2 | 0 | Independent- |
| tication | | tication | | | | | | | | | No |
| | | | | | | | | | | | Impact |
| Authen- | Cloud1 | Role | Cloud3 | 1 | 5 | 200 | 2 | 1 | 1 | 1.64 | Keep as |
| tication | | Service | | | | | | | | | is-No |
| | | | | | | | | | | | decision |
| Authen- | Cloud1 | Invoice | Cloud2 | 0 | 0 | 0 | 0 | 0 | 2 | 0 | Independent- |
| tication | | | | | | | | | | | No |
| | | | | | | | | | | | Impact |
| Authen- | Cloud1 | Payment | Cloud3 | 0 | 0 | 0 | 0 | 0 | 2 | 0 | Independent- |
| tication | | | | | | | | | | | No |
| | | | | | | | | | | | Impact |
| Authen- | Cloud1 | Rasterizer | Cloud1 | 0 | 0 | 0 | 0 | 0 | 2 | 0 | Independent- |
| tication | | | | | | | | | | | No |
| | | | | | | | | | | | Impact |
| Authen- | Cloud1 | Com- | Cloud2 | 0 | 0 | 0 | 0 | 0 | 2 | 0 | Independent- |
| tication | | pression | | | | | | | | | No |
| | | | | | | | | | | | Impact |
| Role | Cloud3 | Authen- | Cloud1 | 1 | 5 | 200 | 2 | 1 | 2 | 3.29 | Relocate |
| Service | | tication | | | | | | | | | if |
| | | | | | | | | | | | Possible |
| Role | Cloud3 | Role | Cloud3 | −1 | 0 | 0 | 0 | 0 | 2 | 0 | Independent- |
| Service | | Service | | | | | | | | | No |
| | | | | | | | | | | | Impact |
| Role | Cloud3 | Invoice | Cloud2 | 1 | 5 | 60 | 3 | 1 | 2 | 1.42 | Keep as |
| Service | | | | | | | | | | | is-No |
| | | | | | | | | | | | decision |
| Role | Cloud3 | Payment | Cloud3 | 0 | 0 | 0 | 0 | 0 | 2 | 0 | Independent- |
| Service | | | | | | | | | | | No |
| | | | | | | | | | | | Impact |
| Role | Cloud3 | Rasterizer | Cloud1 | 0 | 0 | 0 | 0 | 0 | 2 | 0 | Independent- |
| Service | | | | | | | | | | | No |
| | | | | | | | | | | | Impact |
| Role | Cloud3 | Com- | Cloud2 | 0 | 0 | 0 | 0 | 0 | 2 | 0 | Independent- |
| Service | | pression | | | | | | | | | No |
| | | | | | | | | | | | Impact |
| Invoice | Cloud2 | Authen- | Cloud1 | 0 | 0 | 0 | 0 | 0 | 2 | 0 | Independent- |
| | | tication | | | | | | | | | No |
| | | | | | | | | | | | Impact |
| Invoice | Cloud2 | Role | Cloud3 | 1 | 5 | 60 | 3 | 1 | 2 | 1.42 | Keep as |
| | | Service | | | | | | | | | is-No |
| | | | | | | | | | | | decision |
| Invoice | Cloud2 | Invoice | Cloud2 | −1 | 0 | 0 | 0 | 0 | 2 | 0 | Independent- |
| | | | | | | | | | | | No |
| | | | | | | | | | | | Impact |
| Invoice | Cloud2 | Payment | Cloud3 | 1 | 5 | 40 | 2 | 1 | 2 | 0.57 | Keep as |
| | | | | | | | | | | | is-No |
| | | | | | | | | | | | decision |
| Invoice | Cloud2 | Rasterizer | Cloud1 | 1 | 5 | 40 | 7 | 2 | 2 | 2.178 | Keep as |
| | | | | | | | | | | | is-No |
| | | | | | | | | | | | decision |
| Invoice | Cloud2 | Com- | Cloud2 | 0 | 0 | 0 | 0 | 0 | 2 | 0 | Independent- |
| | | pression | | | | | | | | | No |
| | | | | | | | | | | | Impact |
| Payment | Cloud2 | Authen- | Cloud1 | 0 | 0 | 0 | 0 | 0 | 2 | 0 | Independent- |
| | | tication | | | | | | | | | No |
| | | | | | | | | | | | Impact |
| Payment | Cloud3 | Role | Cloud3 | 0 | 0 | 0 | 0 | 0 | 2 | 0 | Independent- |
| | | Service | | | | | | | | | No |
| | | | | | | | | | | | Impact |
| Payment | Cloud3 | Invoice | Cloud2 | 1 | 5 | 40 | 4 | 1 | 2 | 1.25 | Keep as |
| | | | | | | | | | | | is-No |
| | | | | | | | | | | | decision |
| Payment | Cloud3 | Payment | Cloud3 | −1 | 0 | 0 | 0 | 0 | 2 | 0 | Independent- |
| | | | | | | | | | | | No |
| | | | | | | | | | | | Impact |
| Payment | Cloud3 | Rasterizer | Cloud1 | 0 | 0 | 0 | 0 | 0 | 2 | 0 | Independent- |
| | | | | | | | | | | | No |
| | | | | | | | | | | | Impact |
| Payment | Cloud3 | Com- | Cloud2 | 0 | 0 | 0 | 0 | 0 | 2 | 0 | Independent- |
| | | pression | | | | | | | | | No |
| | | | | | | | | | | | Impact |
| Rasterizer | Cloud1 | Authen- | Cloud1 | 0 | 0 | 0 | 0 | 0 | 2 | 0 | Independent- |
| | | tication | | | | | | | | | No |
| | | | | | | | | | | | Impact |
| Rasterizer | Cloud1 | Role | Cloud3 | 0 | 0 | 0 | 0 | 0 | 2 | 0 | Independent- |
| | | Service | | | | | | | | | No |
| | | | | | | | | | | | Impact |
| Rasterizer | Cloud1 | Invoice | Cloud2 | 1 | 5 | 60 | 6 | 2 | 2 | 2.85 | Relocate |
| | | | | | | | | | | | if |
| | | | | | | | | | | | Possible |
| Rasterizer | Cloud1 | Payment | Cloud3 | 0 | 0 | 0 | 0 | 0 | 2 | 0 | Independent- |
| | | | | | | | | | | | No |
| | | | | | | | | | | | Impact |
| Rasterizer | Cloud1 | Rasterizer | Cloud1 | −1 | 0 | 0 | 0 | 0 | 2 | 0 | Independent- |
| | | | | | | | | | | | No |
| | | | | | | | | | | | Impact |
| Rasterizer | Cloud1 | Com- | Cloud2 | 1 | 5 | 55 | 5 | 2 | 2 | 2.12 | Keep as |
| | | pression | | | | | | | | | is-No |
| | | | | | | | | | | | decision |
| Com- | Cloud2 | Authen- | Cloud1 | 0 | 0 | 0 | 0 | 0 | 2 | 0 | Independent- |
| pression | | tication | | | | | | | | | No |
| | | | | | | | | | | | Impact |
| Com- | Cloud2 | Role | Cloud3 | 0 | 0 | 0 | 0 | 0 | 1 2 | 0 | Independent- |
| pression | | Service | | | | | | | | | No |
| | | | | | | | | | | | Impact |
| Com- | Cloud2 | Invoice | Cloud2 | 0 | 0 | 0 | 0 | 0 | 2 | 0 | Independent- |
| pression | | | | | | | | | | | No |
| | | | | | | | | | | | Impact |
| Com- | Cloud2 | Payment | Cloud3 | 0 | 0 | 0 | 0 | 0 | 2 | 0 | Independent- |
| pression | | | | | | | | | | | No |
| | | | | | | | | | | | Impact |
| Com- | Cloud2 | Rasterizer | Cloud1 | 1 | 5 | 50 | 6 | 2 | 2 | 2.34 | Keep as |
| pression | | | | | | | | | | | is-No |
| | | | | | | | | | | | decision |
| Com- | Cloud2 | Com- | Cloud2 | −1 | 0 | 0 | 0 | 0 | 2 | 0 | Independ |
| pression | | pression | | | | | | | | | ent-No |
| | | | | | | | | | | | Impact |

| | | | | | | |
|---|---|---|---|---|---|---|
| Overall | 70 | 1175 | 57 | 19 | 83 | 32.98 |
| Network | | | | | | |
| Distance | | | | | | |

Orchestrator 110 can aggregate proximity scores for all edges defining an application to produce an aggregated proximity score for an application. In reference to Table E, orchestrator 110 can output the aggregated proximity score for the microservices-based application in the source state depicted in Table E of 32.98 based on aggregation of all proximity scores for all edges defining an application.

On completion of establishing at establishing block 1105, orchestrator 110 can proceed to generating block 1106. At generating block 1106, orchestrator 110 can generate candidate hosting states for the application subject to establishing at establishing block 1105 and triggering satisfaction of the criterion at criterion block 1104.

Generating at generating block 1106 can include biasing the generation of rehosting states for evaluation in dependence on pair level parameter value datasets for first and second ones of microservices defining an application. In one embodiment, the generating of candidate rehosting states at generating block 1106 can be biased in favor of candidate rehosting states wherein first and second microservices are specified as being hosted together on a common computing node at an edge endpoint 1100 where (a) a cumulative pair level of each of the first and second microservice satisfies a low threshold and where (b) the microservices are dependent on one another (pair level 1).

In reference to the source state referenced in Table E, the rasterizer and compression microservice have a pair level parameter value to themselves as “1”, so (b) is satisfied. The cumulative pair level (excluding “−1” outliers) of the rasterizer microservice to remaining microservices is 0+0+0+1=1. The cumulative pair level of the compression microservice to remaining microservices is 0+0+0+0=0. Where “1” is specified as the low threshold for (a), orchestrator 110 at generating block 1106 can bias the generation of candidate rehosting states in favor of rehosting states where the rasterizer microservice and the compression microservice are commonly hosted on common computing node at an edge endpoint 1100, and in one embodiment can filter out and exclude candidate rehosting states where the rasterizer microservice and the compression microservice are not commonly hosted on common computing node at an edge endpoint. In other use cases, “0” or an integer other than “1” can be specified as the low threshold for (a). Such selections can be made configurable with use of a user interface presented to an administrator developer user. The described biasing and filtering economizes computing resources by avoiding establishing application characterizing data for filtered out and excluded candidate target rehosting states and evaluations of such filtered out and excluded candidate rehosting states.

Accordingly, there is set forth herein, establishing, for a microservice defining a microservice based application hosted in a source state, edge characterizing data that characterizes a relationship of the microservice to respective ones of remaining microservices defining the microservice based application, wherein the establishing is performed in dependence on observatory data obtained for the microservice based application hosted in the source state; repeating the establishing for second to Nth microservices defining the microservice based application, and outputting from the repeating an application characterizing dataset that characterizes the microservice based application hosted in the source state; generating a plurality of candidate rehosting states for the microservice based application; for respective ones of the candidate rehosting states, producing a candidate application characterizing dataset; identifying, in dependence on the producing, a suitable rehosting state from the plurality of candidate rehosting states; and rehosting the microservice based application for implementation of the suitable rehosting state identified by the identifying, wherein the method includes (i) processing observatory data for determining a dependency of the microservice relative to each other microservice defining the microservices based application, (ii) processing obtained observatory data for determining a dependency of the second microservice relative to each other microservice defining the microservices based application, (iii) ascertaining that the microservice and the second microservice are dependent on one another, (iv) determining that a criterion is satisfied in dependence on result of the processing of (i) the processing of (ii), and the ascertaining of (iii) and (iv) filtering out and excluding certain candidate rehosting states from the generating responsively to the determining, wherein the filtering out and excluding includes filtering out and excluding from the generating candidate target rehosting datasets other than candidate rehosting datasets wherein the microservice and the second microservice are commonly hosted on common computing node of an edge endpoint.

In another embodiment of orchestrator 110 filtering out and excluding generated target candidate rehosting states, orchestrator 110 can restrict the generation of candidate rehosting states so that there are excluded from generation candidate rehosting states where a determined (by observatory data processing) dependent pair of microservices (pair level 1 as described in Table B) are moved to network distances (Table C) greater than a current source state network distance.

In another embodiment of orchestrator 110 filtering out and excluding generated target candidate rehosting states, orchestrator 110 can restrict the generation of candidate rehosting states so that there are excluded from generation candidate rehosting states other than candidate rehosting states where at least one determined (by observatory data processing) dependent pair of microservice (pair level 1 of Table B) having a network distance (Table C) of greater than 3 is moved to a reduced network distance.

In another embodiment of orchestrator 110 filtering out and excluding generated target candidate rehosting states, orchestrator 110 can restrict the generation of candidate rehosting states in dependence on selected data input by a user to a user interface. Orchestrator 110 on completion of establishing block 1105 can present the established application characterizing data of Table E to a user interface displayed on a UE device of UE devices 160A-160Z of a user sending the selection data at send block 1601. The displayed user interface can present prompting data such as the action prompting data of the last column “score decision” which prompting data can be based on a proximity score (proximity score column) for the particular microservice pair associated to the given row. The displayed user interface presenting the prompting data can include the configurable threshold value which controls the display of the prompting data. In the example of Table E, the THRESHOLD=2.5 value can be user configurable as the condition triggering the presentment of the prompting data “Relocate if Possible” as depicted in the actions decision column. Responsive to the prompting data “Relocate if Possible” can enter data into the presented user interface to indicate a requested relocated hosting locations for the relevant microservice pair of the given row.

Based on such request, orchestrator 110 can generate at generating block 1106 candidate target rehosting states restricted and filtered according to the request, and can responsively perform establishing and deciding at block 1110 and 1111 for performance of rendering an action decision in relation to the restrictively generated candidate target states.

On completion of generating block 1106, orchestrator 110 can proceed to selecting block 1107. At selecting block 1107, orchestrator 110 can select a trained predictive learning model from models area 2126 for use in generating predictions as to observatory data associated to respective ones of the generated candidate target rehosting states generated at generating block 1106.

Embodiments herein recognize that some microservice-based applications may observe limited rehosting states in their life cycles, and so history data for use in training of predictive model can be limited. On the other hand, other microservice based applications may be hosted multiple times in their lifecycles. Embodiments herein can increase pool of machine learning predictive models according to observatory data predictive model 3102 for use in producing observatory data predictions by use of similarity scoring for scoring a similarity of the current application triggering criterion block 1104 to an application associated to a model stored in models area 2126.

Orchestrator 110 at selecting block 1107 can employ a similarity scoring technique as set forth in reference to Eq. 5.

$$S = F 1 W 1 + F 2 W 2 \qquad ( Eq . 5 )$$

Where S is a similarity score between the current application and a candidate application associated to a model of models area 2126, F1 is a first factor, F2 is a second factor, and W1 and W2 are weights associated to the various factors.

In one embodiment, the first factor can be a role scoring factor. Microservice-based applications herein can have microservices that have roles that map to microservice names, e.g., authentication microservice, payment microservice, invoice microservice and the like.

Under the similarity scoring factor F1, orchestrator 110 can identify in a candidate application a microservice corresponding to each microservice of a current application and can assign scoring values to each pair of corresponding microservices according with use of a decision data structure having characteristics set forth in Table F.

TABLE F

| | Current application | Corresponding | Similarity |
|---|---|---|---|
| Row | microservice | microservice | scoring value |
| 1 | Notification | Notification | 1.0 |
| | microservice | microservice | |
| 2 | Notification | Messaging | 0.8 |
| | microservice | microservice | |
| 3 | Notification | Chat | 0.7 |
| | microservice | microservice | |
| . . . | . . . | . . . | . . . |
| 56 | Order microservice | Order microservice | 1.0 |
| 57 | Order microservice | Inventory microservice | 0.8 |
| 58 | Order microservice | Shipping microservice | 0.8 |
| . . . | . . . | . . . | . . . |

Under the role similarity scoring factor F1, orchestrator 110 can assign scoring values with use of the decision data structure of Table F. Orchestrator 110 under factor F1 can aggregate the individual microservice scoring values to produce an aggregate role similarity scoring value for an entire application as compared to respective candidate applications having an associated models stored in models area 2126.

Orchestrator 110 under factor F2 can scale scoring values according to the similarity in client loading between the current application and a candidate application associated to a model in models area 2126. To assess client loading of an application, orchestrator 110 can analyze metrics such as request rates, active user sessions, API call frequency, latency, response times, resource utilization (CPU, memory, bandwidth), and error rates. Additionally, orchestrator 110 can examine access logs for client IPs, timestamps, and endpoints hit, authentication logs for active users, user behavior logs like clickstreams, and rate-limiting or throttling logs. These insights collectively reveal user activity levels and system load patterns. Orchestrator 110 can subject multiple candidate applications having associated models to similarity analysis with use of Eq. 5.

Orchestrator 110 at selecting block 1107 can select the high-scoring application and associated model in response to similarity analysis according to Eq. 5. Orchestrator 110 can additionally or alternatively perform the similarity analysis described in reference to Eq. 5 in the performance of training described in reference to send block 1103 and training block 2601 so that multiple models can be trained with use of collected historical observatory data associated to applications other than an application of the trained model. In such manner, orchestrator 110 in one use case can increase a number of models that are sufficiently trained and available for inferencing, thereby economizing consumption of computing resources by facilitation of increased instances of intelligent rehosting driven with use of query of an observatory data predictive model. The training of models at training block 2601 with use of observatory data obtained from applications that are similar to but not the same as the application to which the model is precisely associated in one use case can reduce the number of models that are subject to training, and thus can economize computing resources associated with such training.

On completion of selecting block 1107, orchestrator 110 can proceed to send block 1108. At send block 1108, orchestrator 110 can send inferencing data for inferencing the selected trained model. Inferencing can be performed in the manner described with reference to observatory data predictive model 3102 described as set forth in FIG. 4.

In response to the inferencing performed at send block 1108, the inferenced model can send return data at send block 2602. In response to receipt the return data at send block 2602, the inferenced selected model can return predicted observatory data as set forth in reference to FIG. 4.

On receipt of the return data, orchestrator 110 can proceed to decision block 1109. At decision block 1109, orchestrator 110 can ascertain whether the return predicted observatory data is for the last generated candidate target state generated at generating block 1106.

On the determination that the last return data for the last generated candidate target state has not been received, orchestrator 110 can return to a stage preceding block 1108 and can iteratively perform the loop of blocks 1108-1109 until orchestrator 110 determines at last decision block 1109 that return data for the last generated candidate target state has been received. When orchestrator 110 determines at decision block 1109 that all return data for all candidate target states have been received, orchestrator 110 can proceed to establishing block 1110.

At establishing block 1110, orchestrator 110 can establish application characterizing data for each candidate rehosting state generated at generating block 1106. At establishing block 1110 orchestrator 110 can perform establishing in the manner of establishing block 1105 with the establishing performed using predicted observatory values predicted at blocks 1108 and sent at send block 2602 rather than actual observatory values, as was performed at establishing block 1105. A multiple data center hosting computing environment simulator run by orchestrator 110 for return of predicted observatory data at establishing block 1110 can integrate trained predictive models according to observatory data predictive model 3102 for return of predicted observatory data parameter values. The simulator can perform optimizing resource allocation, load balancing, and failover mechanisms. Using machine learning (ML), the simulator can predict future load patterns, network latencies, failure probabilities, and optimal scaling strategies. Supervised learning models (e.g., Random Forest, XGBoost, or deep learning models like LSTMs) can be trained on historical system telemetry, such as CPU usage, memory consumption, request rates, and failure logs, to anticipate infrastructure needs before bottlenecks arise. Additionally, reinforcement learning (RL) can be leveraged by the simulator run by orchestrator 110 for dynamic decision-making in orchestrating deployments, ensuring cost efficiency while maintaining service reliability. The simulator can also employ time-series forecasting techniques (e.g., ARIMA, Prophet) to predict workload spikes across data centers, enabling preemptive scaling and intelligent routing. Simulation-based AI frameworks like Monte Carlo simulations can evaluate different failure scenarios, helping fine-tune redundancy mechanisms. To enhance predictive accuracy, the simulator run by orchestrator 110 can integrate eBPF-based observability tools for real-time kernel-level insights into system behavior, combined with distributed tracing (e.g., OpenTelemetry) for tracking request flows. Cloud-native technologies like Kubernetes with autoscalers, service mesh (e.g., Istio), and AI-driven monitoring tools (e.g., Prometheus with anomaly detection plugins) can provide adaptive orchestration. Furthermore, graph-based neural networks can model the data center topology and predict optimal request routing paths dynamically based on evolving network conditions. The simulator can also employ federated learning to improve predictions across multiple data centers without centralizing sensitive telemetry data, enhancing privacy and compliance. By integrating these technologies, the simulator creates a self-learning, adaptive microservice hosting environment capable of dynamically optimizing resource distribution, minimizing downtime, and improving overall system resilience across geographically distributed data centers. The training of models at training block 2601 with use of observatory data obtained from applications that are similar to but not the same as the application to which the model is precisely associated can reduce the number of models that are subject to training, and thus can economize computing resources associated with such training.

In Table G there is set forth application characterizing data for a candidate rehosting target state.

TABLE G

| | | | | | | | | | | | THRESHOLD = |
|---|---|---|---|---|---|---|---|---|---|---|---|
| Parameters | | | | | | | | | | | 2.5 |
| Micro- | Data | Micro- | Data | Pair | Network | Interaction | Latency | Data | Security | Proximity | Score |
| service i | Center | service j | Center | Level | Distance | Frequency | (ms) | Sharing | Context | Score | Decision |
| UI | Client | Authen- | Cloud | 1 | 5 | 100 | 4 | 1 | 2 | 3.29 | Relocate |
| | | tication | 1 | | | | | | | | if |
| | | | | | | | | | | | Possible |
| UI | Client | Role | Cloud | 0 | 0 | 0 | 0 | 0 | 2 | 0 | Independent- |
| | | Service | 1 | | | | | | | | No |
| | | | | | | | | | | | Impact |
| UI | Client | Invoice | Cloud | 1 | 5 | 100 | 3 | 1 | 2 | 2.44 | Keep |
| | | | 2 | | | | | | | | as is- |
| | | | | | | | | | | | No |
| | | | | | | | | | | | decision |
| UI | Client | Payment | Cloud | 1 | 5 | 50 | 3 | 1 | 2 | 1.17 | Keep |
| | | | 2 | | | | | | | | as is- |
| | | | | | | | | | | | No |
| | | | | | | | | | | | decision |
| UI | Client | Rasterizer | Client | 0 | 0 | 0 | 0 | 0 | 2 | 0 | Independent- |
| | | | | | | | | | | | No |
| | | | | | | | | | | | Impact |
| UI | Client | Com- | Client | 1 | 1 | 120 | 3 | 2 | 1 | 0.20 | Keep |
| | | pression | | | | | | | | | as is- |
| | | | | | | | | | | | No |
| | | | | | | | | | | | decision |
| Authen- | Cloud | Authen- | Cloud | −1 | 0 | 0 | 0 | 0 | 2 | 0 | Independent- |
| tication | 1 | tication | 1 | | | | | | | | No |
| | | | | | | | | | | | Impact |
| Authen- | Cloud | Role | Cloud | 1 | 3 | 200 | 2 | 1 | 2 | 1.93 | Keep |
| tication | 1 | Service | 1 | | | | | | | | as is- |
| | | | | | | | | | | | No |
| | | | | | | | | | | | decision |
| Authen- | Cloud | Invoice | Cloud | 0 | 0 | 0 | 0 | 0 | 2 | 0 | Independent- |
| tication | 1 | | 2 | | | | | | | | No |
| | | | | | | | | | | | Impact |
| Authen- | Cloud | Payment | Cloud | 0 | 0 | 0 | 0 | 0 | 2 | 0 | Independent- |
| tication | 1 | | 2 | | | | | | | | No |
| | | | | | | | | | | | Impact |
| Authen- | Cloud | Rasterizer | Client | 0 | 0 | 0 | 0 | 0 | 2 | 0 | Independent- |
| tication | 1 | | | | | | | | | | No |
| | | | | | | | | | | | Impact |
| Authen- | Cloud | Com- | Client | 10 | 0 | 0 | 0 | 0 | 2 | 0 | Independent- |
| tication | 1 | pression | | | | | | | | | No |
| | | | | | | | | | | | Impact |
| Role | Cloud | Authen- | Cloud | 1 | 3 | 200 | 2 | 1 | 1 | 0.96 | Keep |
| Service | 1 | tication | 1 | | | | | | | | as is- |
| | | | | | | | | | | | No |
| | | | | | | | | | | | decision |
| Role | Cloud | Role | Cloud | −1 | 0 | 0 | 0 | 0 | 2 | 0 | Independent- |
| Service | 1 | Service | 1 | | | | | | | | No |
| | | | | | | | | | | | Impact |
| Role | Cloud | Invoice | Cloud | 1 | 5 | 60 | 3 | 1 | 2 | 1.42 | Keep |
| Service | 1 | | 2 | | | | | | | | as is- |
| | | | | | | | | | | | No |
| | | | | | | | | | | | decision |
| Role | Cloud | Payment | Cloud | 0 | 0 | 0 | 0 | 0 | 2 | 0 | Independent- |
| Service | 1 | | 2 | | | | | | | | No |
| | | | | | | | | | | | Impact |
| Role | Cloud | Rasterizer | Client | 0 | 0 | 0 | 0 | 0 | 2 | 0 | Independent- |
| Service | 1 | | | | | | | | | | No |
| | | | | | | | | | | | Impact |
| Role | Cloud | Com- | Client | 0 | 0 | 0 | 0 | 0 | 2 | 0 | Independent- |
| Service | 1 | pression | | | | | | | | | No |
| | | | | | | | | | | | Impact |
| Invoice | Cloud | Authen- | Cloud | 0 | 0 | 0 | 0 | 0 | 2 | 0 | Independent- |
| | 2 | tication | 1 | | | | | | | | No |
| | | | | | | | | | | | Impact |
| Invoice | Cloud | Role | Cloud | 1 | 5 | 60 | 3 | 1 | 2 | 1.42 | Keep |
| | 2 | Service | 1 | | | | | | | | as is- |
| | | | | | | | | | | | No |
| | | | | | | | | | | | decision |
| Invoice | Cloud | Invoice | Cloud | −1 | 0 | 0 | 0 | 0 | 2 | 0 | Independent- |
| | 2 | | 2 | | | | | | | | No |
| | | | | | | | | | | | Impact |
| Invoice | Cloud | Payment | Cloud | 1 | 3 | 40 | 2 | 1 | 1 | 0.15 | Keep |
| | 2 | | 2 | | | | | | | | as is- |
| | | | | | | | | | | | No |
| | | | | | | | | | | | decision |
| Invoice | Cloud | Rasterizer | Client | 1 | 5 | 40 | 3 | 2 | 2 | 0.81 | Keep |
| | 2 | | | | | | | | | | as is- |
| | | | | | | | | | | | No |
| | | | | | | | | | | | decision |
| Invoice | Cloud | Com- | Client | 0 | 0 | 0 | 0 | 0 | 2 | 0 | Independent- |
| | 2 | pression | | | | | | | | | No |
| | | | | | | | | | | | Impact |
| Payment | Cloud | Authen- | Cloud | 0 | 0 | 0 | 0 | 0 | 2 | 0 | Independent- |
| | 2 | tication | 1 | | | | | | | | No |
| | | | | | | | | | | | Impact |
| Payment | Cloud | Role | Cloud | 0 | 0 | 0 | 0 | 0 | 2 | 0 | Independent- |
| | 2 | Service | 1 | | | | | | | | No |
| | | | | | | | | | | | Impact |
| Payment | Cloud | Invoice | Cloud | 1 | 3 | 40 | 4 | 1 | 1 | 0.35 | Keep |
| | 2 | | 2 | | | | | | | | as is- |
| | | | | | | | | | | | No |
| | | | | | | | | | | | decision |
| Payment | Cloud | Payment | Cloud | −1 | 0 | 0 | 0 | 0 | 2 | 0 | Independent- |
| | 2 | | 2 | | | | | | | | No |
| | | | | | | | | | | | Impact |
| Payment | Cloud | Rasterizer | Client | 0 | 0 | 0 | 0 | 0 | 2 | 0 | Independent- |
| | 2 | | | | | | | | | | No |
| | | | | | | | | | | | Impact |
| Payment | Cloud | Com- | Client | 0 | 0 | 0 | 0 | 0 | 2 | 0 | Independent- |
| | 2 | pression | | | | | | | | | No |
| | | | | | | | | | | | Impact |
| Rasterizer | Client | Authen- | Cloud | 0 | 0 | 0 | 0 | 0 | 2 | 0 | Independent- |
| | | tication | 1 | | | | | | | | No |
| | | | | | | | | | | | Impact |
| Rasterizer | Client | Role | Cloud | 0 | 0 | 0 | 0 | 0 | 2 | 0 | Independent- |
| | | Service | 1 | | | | | | | | No |
| | | | | | | | | | | | Impact |
| Rasterizer | Client | Invoice | Cloud | 1 | 5 | 60 | 6 | 2 | 2 | 2.85 | Relocate |
| | | | 2 | | | | | | | | if |
| | | | | | | | | | | | Possible |
| Rasterizer | Client | Payment | Cloud | 0 | 0 | 0 | 0 | 0 | 2 | 0 | Independent- |
| | | | 2 | | | | | | | | No |
| | | | | | | | | | | | Impact |
| Rasterizer | Client | Rasterizer | Client | −1 | 0 | 0 | 0 | 0 | 2 | 0 | Independent- |
| | | | | | | | | | | | No |
| | | | | | | | | | | | Impact |
| Rasterizer | Client | Com- | Client | 1 | 3 | 55 | 2 | 2 | 1 | 0.17 | Keep |
| | | pression | | | | | | | | | as is- |
| | | | | | | | | | | | No |
| | | | | | | | | | | | decision |
| Com- | Client | Authen- | Cloud | 0 | 0 | 0 | 0 | 0 | 2 | 0 | Independent- |
| pression | | tication | 1 | | | | | | | | No |
| | | | | | | | | | | | Impact |
| Com- | Client | Role | Cloud | 0 | 0 | 0 | 0 | 0 | 2 | 0 | Independent- |
| pression | | Service | 1 | | | | | | | | No |
| | | | | | | | | | | | Impact |
| Com- | Client | Invoice | Cloud | 0 | 0 | 0 | 0 | 0 | 2 | 0 | Independent- |
| pression | | | 2 | | | | | | | | No |
| | | | | | | | | | | | Impact |
| Com- | Client | Payment | Cloud | 0 | 0 | 0 | 0 | 0 | 2 | 0 | Independent- |
| pression | | | 2 | | | | | | | | No |
| | | | | | | | | | | | Impact |
| Com- | Client | Rasterizer | Client | 1 | 3 | 50 | 3 | 2 | 1 | 0.27 | Keep |
| pression | | | | | | | | | | | as is- |
| | | | | | | | | | | | No |
| | | | | | | | | | | | decision |
| Com- | Client | Com- | Client | −1 | 0 | 0 | 0 | 0 | 2 | 0 | Independent- |
| pression | | pression | | | | | | | | | No |
| | | | | | | | | | | | Impact |
| | | | Overall | | 54 | 1175 | 43 | 19 | 78 | 17.50 | |
| | | | Network | | | | | | | | |
| | | | Distance | | | | | | | | |

At establishing block 1110, orchestrator 110 can establish application characterizing data for a candidate target state of the current application as set forth in Table G. The proximity score parameter values specified in Table G defining edge characterizing data can be based on predicted observatory data returned at return data send block 2602. At establishing block 1110, orchestrator 110 can establish multiple datasets as set forth in Table G, i.e., one for each candidate target rehosting state generated at generating block 1106.

On completion of establishing block 1110, orchestrator 110 can proceed to action decision block 1111. At action decision block 1111, orchestrator 110 can return an action decision. The action decision, in one embodiment, can be the action decision to identify a certain candidate target rehosting state as being suitable for implementation the candidate target rehosting state producing the lowest aggregate proximity score.

At action decision block 1111, orchestrator 110 can additionally or alternatively return an action decision to qualify implementation of a candidate target state based on the candidate target rehosting state producing a predicted aggregate proximity score (17.50 in Table G) lower than an actual proximity score calculated for the current source state. At action decision block 1111, orchestrator 110 can additionally or alternatively return an action decision to qualify implementation a candidate target state producing a predicted aggregate proximity score satisfying a threshold proximity score.

Orchestrator 110 on completion of establishing block 1110 can present the generated application characterizing data of Table G to a user interface displayed on a UE device of UE devices 160A-160Z of a user sending the selection data at send block 1601. The displayed user interface can present prompting data such as the action prompting data of the last column “score decision” which prompting data can be based on a proximity score (proximity score column) for the particular microservice pair associated to the given row. The displayed user interface presenting the prompting data can include the configurable threshold value which controls the display of the prompting data. In the example of Table E, the THRESHOLD=2.5 value can be user configurable as the condition triggering the presentment of the prompting data “Relocate if Possible” as depicted in the actions decision column. Responsive to the prompting data “Relocate if Possible” can enter control data into the presented user interface to indicate a requested relocated hosting locations for the relevant microservice pair of the given row. Based on such request, orchestrator 110 can loop back to generating block 1106 to generate additional candidate target rehosting states restricted according to the request, and can responsively perform establishing and deciding at block 1110 and 1111 for performance of rendering an action decision in relation to the restrictively generated candidate target states.

In reference to action decision block 1111, orchestrator 110 can ascertain that the candidate target state of Table G has a lower aggregate proximity score, i.e., 17.5, than the proximity score for the source state, i.e., 32.98 and thus can qualify the candidate target state having the application characterizing data of Table G for rehosting. In another embodiment, orchestrator 110 at action decision block 1111 can identify the candidate rehosting state associated to the application characterizing data of Table G as being suitable for rehosting based on the candidate rehosting state producing the lowest aggregate proximity score amongst all the remaining candidate target states having associated application characterizing datasets established at establishing block 1110.

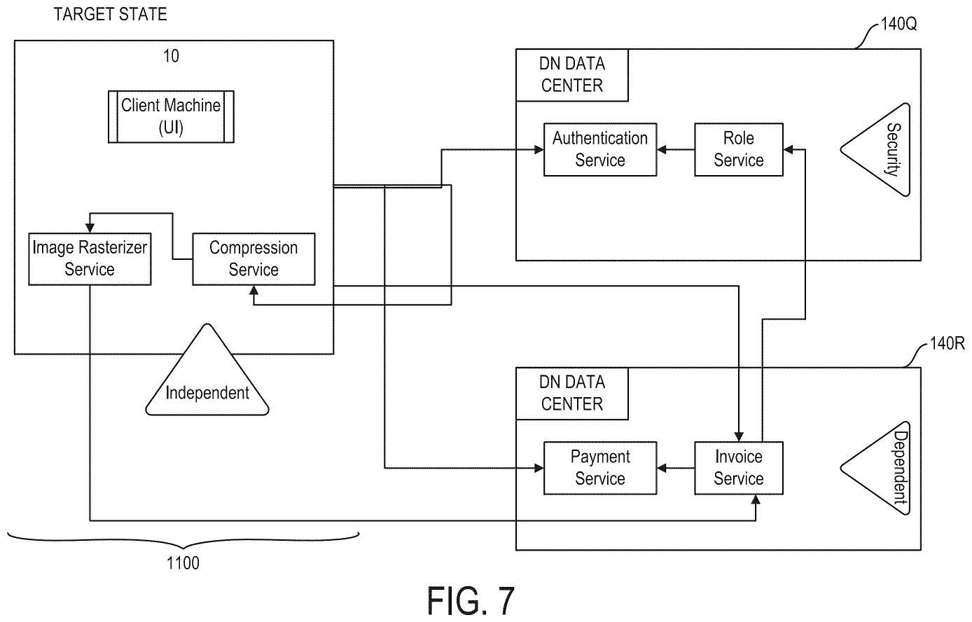

In another embodiment, orchestrator 110 at action decision block 1111 can qualify the application associated to the application characterizing data of Table G based on the candidate rehosting state of Table G producing an aggregate proximity score that satisfies a threshold. The target state of Table G is set forth schematically in FIG. 7. Referring to the target candidate rehosting state of Table G, and FIG. 7, the user interface (UI) microservice can be hosted on a client machine defined by a computing node 10 at an edge endpoint 1100, the authentication microservice hosted on data network data center 140Q, the roles microservice can be hosted on data network data center 140S, the invoice microservice can be hosted on data network data center 140R, the rasterizer microservice can be hosted on the client machine defined by a computing node 10 at an edge endpoint 1100, the payment microservice can be hosted on data network data center 140R, and the compression microservice can be hosted on the client machine defined by the computing node 10 at edge endpoint 1100.

On completion of action decision block 1111, orchestrator 110 can proceed to send block 1112. At send block 1112, orchestrator 110 can send command data for receipt by computer environments 140A-140Z. The command data sent at block 1112 can include command data specifying decommissioning command data, specifying decommissioning of a microservice at a first hosting location and deploying the microservice at a second hosting location. On receipt of the command data sent at send block 1112, computer environments 140A-140Z at action block 1404 can perform action, e.g., decommissioning or deploying in accordance with the command data sent at send block 1112. In respect to sending command data at block 1112, orchestrator 110 can automate the rehosting of a microservice from a first data center to a second by managing infrastructure provisioning, container deployment, networking, data synchronization, and traffic redirection while minimizing downtime. Orchestrator 110 can, e.g., allocate necessary computer, storage, and network resources in the target data center, ensuring compatibility with the microservice's requirements. If containerized, orchestrator 110 can deploy and schedule workloads using orchestration tools like Kubernetes. Orchestrator 110 can configure networking to maintain service discovery and proper routing through load balancers, DNS updates, and ingress controllers. Stateful services require careful data replication or migration to prevent inconsistency or loss. Orchestrator 110 can synchronize environment configurations, secrets, and certificates securely. Deployment strategies like blue-green, rolling updates, or canary releases gradually transition traffic to the new data center, reducing risk. Continuous health monitoring can ensure service availability, automatically restarting failed instances or rolling back if needed. Traffic management mechanisms like global load balancers or DNS-based failover can redirect requests dynamically to the second data center. Security policies, firewall rules, and compliance enforcement ensure a secure and regulatory-compliant transition. Once migration is validated, orchestrator 110 can decommission resources in the first data center to optimize costs and resource utilization. This automation streamlines migration, reduces human intervention, and maintains operational stability.

Orchestrator 110, on completion of send block 1112, can proceed to return block 1113. At return block 1113, orchestrator 110 can return to a stage preceding send block 1101 to receive a next iteration of selection data sent at block 1601, observatory data sent at block 1402, and source code data sent at block 1403. Orchestrator 110 can iteratively perform the loop of blocks 1101-1113 for deployment period of orchestrator 110. Orchestrator 110 can be running multiple instances of the loop of blocks 1101-1113 for orchestration of multiple different microservice based applications concurrently, simultaneously and contemporaneously.

On completion of action block 1404, computer environments 140A-140Z can proceed to return block 1405. Computer environments 140A-140Z can iteratively perform the loop of blocks 1401-1405 during a deployment period of computer environments 140A-140Z.

Models area 2126 on completion of send block 2602 can proceed to return block 2603. At return block 2603 models area 2126 can return to a stage preceding training block 2601 for performance of a next iteration of the loop of blocks 2601-2603.

UE devices 160A-160Z, on completion of send block 1601, can proceed to return block 1602. UE devices 160A-160Z can iteratively perform the loop of blocks 1601-1602 during a deployment period of UE devices 160A-160Z.

Embodiments herein recognize that in modern computing, significant resources are consumed by server clusters to handle business logic and backend computations, while client devices have become more powerful than ever. Despite their capabilities, client devices typically execute only user interface (UI) logic using standardized protocols and technologies (e.g., HTML5, CSS, JavaScript) and frameworks like ReactJS and Angular. Embodiments herein recognize that these applications rely on shared services hosted on servers for data exchange and backend processing.

Embodiments herein recognize that a challenge lies in the inefficient separation of logic between servers and clients. Embodiments herein recognize that while some computation and services are naturally suited for servers, other logic segments could be executed closer to or directly on the client-side. However, client systems are heterogeneous, with varying capabilities and no intrinsic understanding of server technologies.

Embodiments herein explore what may be termed a “proximity-based asset deployment model”. Embodiments herein can provide for bundling independent microservices closer to client machines or within local networks to reduce latency and improve performance.

Embodiments herein can ensure that tightly coupled microservices or those critical to application functionality are placed near client applications to maintain efficiency and responsiveness. Embodiments herein provide a method to quantify the degree of proximity between services and applications, optimizing the placement of microservices by pairing them to strike a balance between computation load distribution, resource utilization, and latency reduction. Embodiments herein provide for microservice placement. Embodiments herein can provide identifying which microservices can be hosted locally or within proximity to the client and which must remain on servers.

Embodiments herein can provide proximity quantification. Embodiments herein can provide defining and calculating a metric for the “degree of proximity” to determine optimal service placement. The proximity parameter value helps to identify how microservices across the networks are clustered together can be based on the number of parameters (e.g., latency, call frequency, security dependencies, data sharing, etc.)

Embodiments herein can take into consideration individual client objectives, requirements, and parameters to be considered for performing microservices pairing. Individual client parameter requirements can be mapped to the proximity rule engine model to calculate the proximity target decision. Depending on the number of microservices to be considered, if there is a large dataset then machine learning model can be used to calculate the degree of proximity to determine optimal service placement and pair microservices based on service dependency, latency, service coupling, and the like.

Embodiments herein can provide a decision framework which improves throughput by pairing microservices which are tightly coupled to deploy close together, keeping in mind the client project objective. Embodiments herein recognize that there is currently no method available to develop a proximity-based microservice deployment model that quantifies service placement for optimized performance and resource utilization, enabling better integration of computational capabilities across heterogeneous client systems and server infrastructures.

Embodiments herein recognize that running of an application requires computation, memory, local storage and external storage. For scaling requirement, if the application services communicate with another services, that must expose a network and the infrastructure cost for intercommunication amongst microservices can increase. Embodiments herein recognize that microservices application components can in some cases be placed in client computer to take benefits of local computing to decrease bandwidth and network requirements.

Various available tools, libraries, and/or services can be utilized for implementation of trained predictive models herein trained by machine learning, such as predictive model 3102. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Trained predictive models herein can employ use, e.g., of artificial neural networks (ANNs) support vector machines (SVM), Bayesian networks, and/or other machine learning technologies.

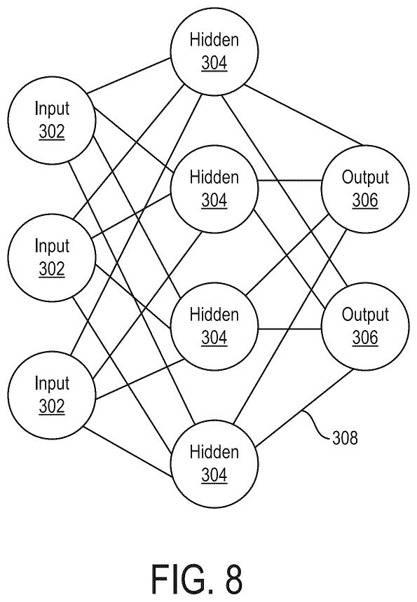

FIG. 8 is an illustration of an example ANN architecture for trained predictive models herein trained by machine learning, such as predictive model 3102.

One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN can be configured for a specific application, such as the applications discussed in connection with predictive model 3102.

Referring now to FIG. 8, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Weighted connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output, which can be referring to as outcome training data as referenced in connection with predictive model 3102 herein. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process can continue until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, weights of weighted connections 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, weights of weighted connections 308 may be implemented as resistive processing units (RPUs), generating a predictable current output when an input voltage is applied in accordance with a settable resistance.

Certain embodiments herein may offer various technical computing advantages involving computing advantages to address problems arising in the realm of computer systems. Embodiments hearing can include establishing edge characterizing data that characterizes relationships between microservices that define a microservice based application. Establishing of edge characterizing data can include utilization of observatory data including metrics data and logging data. Embodiments herein can include generating candidate target rehosting states and evaluating such candidate target rehosting states. Evaluating a candidate target rehosting state can include establishing for respective candidate target rehosting states application characterizing data that characterizes the application in respective candidate rehosting state. For establishing application characterizing data of a candidate rehosting state, embodiments herein can perform predicting of observatory data of the application in the candidate rehosting state. Performing such predicting can include inferencing a trained machine learning model trained using historical observatory data. Embodiments herein can include various features in respect to rehosting a microservice based application for reduced latency, decreased congestion, increased accuracy, and economization of computing resource, selection and/or training of a limited number of machine learning models and in respect to filtering techniques for limiting a number of candidate target rehosting states for evaluation. Embodiments herein can improve performance of a computer system by providing automated rehosting of a microservice based application. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

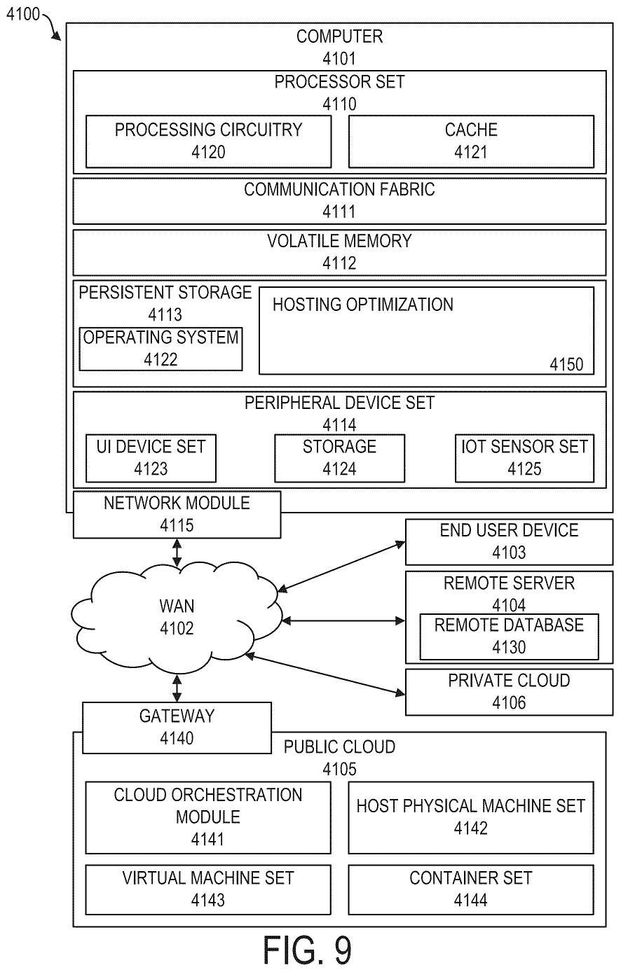

In reference to FIG. 9 there is set forth a description of a computing environment 4100 that can include one or more computer 4101. In one example, computing node 10 as set forth herein can be provided in accordance with computer 4101 as set forth in FIG. 9.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time. Embodiments herein are described with reference to prophetic illustrative examples.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 9. In one aspect, a computing environment 4100 contains an example of an environment for the execution of at least some of the computer code involved in performing the inventive methods, such as code 4150 for performing hosting optimization described with reference to FIGS. 1-8. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
establishing, for a microservice defining a microservice based application hosted in a source state, edge characterizing data that characterizes a relationship of the microservice to respective ones of remaining microservices defining the microservice based application, wherein the establishing is performed in dependence on observatory data obtained for the microservice based application hosted in the source state;
repeating the establishing for second to Nth microservices defining the microservice based application, and outputting from the repeating an application characterizing dataset that characterizes the microservice based application hosted in the source state;
generating a plurality of candidate rehosting states for the microservice based application;
for respective ones of the candidate rehosting states, producing a candidate application characterizing dataset;
identifying, in dependence on the producing, a suitable rehosting state from the plurality of candidate rehosting states; and
rehosting the microservice based application for implementation of the suitable rehosting state identified by the identifying.

2. The computer implemented method of claim 1, wherein the producing the candidate application characterizing data for the respective ones of the candidate rehosting states includes performing the producing in dependence on predicted observatory data predicted for the respective ones of the candidate rehosting states.

3. The computer implemented method of claim 1, wherein the method includes training a predictive model using data of the observatory data, wherein the producing the candidate application characterizing data for the respective ones of the candidate rehosting states includes performing the producing in dependence on predicted observatory data predicted for the respective ones of the candidate rehosting states, wherein obtaining the predicted observatory data predicted for at least one of the candidate rehosting states includes inferencing the predictive model.

4. The computer implemented method of claim 1, wherein the characterizing data that characterizes a relationship of the microservice to respective ones of remaining microservices defining the microservice based application includes proximity parameter values that are determined based on logging data and metrics data of the observatory data obtained for the microservice based application hosted in the source state.

5. The computer implemented method of claim 1, wherein the characterizing data that characterizes a relationship of the microservice to respective ones of remaining microservices defining the microservice based application includes a proximity parameter value that characterizes a relationship between the microservice and a certain remaining microservice of the remaining microservice, wherein the proximity parameter value is determined in dependence on messaging latency between the microservice and the certain remaining microservice and on shared resources between the microservice and the certain remaining resources.

6. The computer implemented method of claim 1, wherein identifying the suitable rehosting state from the candidate rehosting states includes comparing data of the candidate application characterizing dataset produced for respective ones of the candidate rehosting state to data of the application characterizing dataset that characterizes the microservice based application hosted in the source state.

7. The computer implemented method of claim 1, wherein identifying the suitable rehosting state from the candidate rehosting states includes comparing an aggregate proximity parameter value of the candidate application characterizing dataset produced for respective ones of the candidate rehosting state to an aggregate proximity parameter value of the application characterizing dataset that characterizes the microservice based application hosted in the source state.

8. The computer implemented method of claim 1, wherein the method includes discovering that characterizing data that characterizes a relationship between the microservice and a particular microservice of the remaining microservices satisfies one or more criterion, and wherein the generating includes performing the generating in dependence on the discovering.

9. The computer implemented method of claim 1, wherein the method includes (i) processing observatory data for determining a dependency of the microservice relative to each other microservice defining the microservices based application, (ii) processing obtained observatory data for determining a dependency of the second microservice relative to each other microservice defining the microservices based application, (iii) determining that a criterion is satisfied in dependence on result of the processing of (i) and the processing of (ii), and (iv) filtering out and excluding certain candidate rehosting states from the generating responsively to the determining.

10. The computer implemented method of claim 1, wherein the method includes (i) processing observatory data for determining a dependency of the microservice relative to each other microservice defining the microservices based application, (ii) processing obtained observatory data for determining a dependency of the second microservice relative to each other microservice defining the microservices based application, (iii) ascertaining that the microservice and the second microservice are dependent on one another, (iv) determining that a criterion is satisfied in dependence on result of the processing of (i) the processing of (ii), and the ascertaining of (iii) and (iv) filtering out and excluding certain candidate rehosting states from the generating responsively to the determining, wherein the filtering out and excluding includes filtering out and excluding from the generating candidate target rehosting datasets other than candidate rehosting datasets wherein the microservice and the second microservice are commonly hosted on common computing node of an edge endpoint.

11. The computer implemented method of claim 1, wherein the characterizing data that characterizes a relationship of the microservice to respective ones of remaining microservices defining the microservice based application includes a proximity parameter value that characterizes a relationship between the microservice and a certain remaining microservice of the remaining microservice, wherein the proximity parameter value is determined in dependence on messaging latency between the microservice and the certain remaining microservice and on shared resources between the microservice and the certain remaining resources, wherein the method includes (i) processing observatory data for determining a dependency of the microservice relative to each other microservice defining the microservices based application, (ii) processing obtained observatory data for determining a dependency of the second microservice relative to each other microservice defining the microservices based application, (iii) ascertaining that the microservice and the second microservice are dependent on one another, (iv) determining that a criterion is satisfied in dependence on result of the processing of (i) the processing of (ii), and the ascertaining of (iii) and (iv) filtering out and excluding certain candidate rehosting states from the generating responsively to the determining, wherein the filtering out and excluding includes filtering out and excluding from the generating candidate target rehosting datasets other than candidate rehosting datasets wherein the microservice and the second microservice are commonly hosted on common computing node of an edge endpoint, wherein identifying the suitable rehosting state from the candidate rehosting states includes comparing an aggregate proximity parameter value of the candidate application characterizing dataset produced for respective ones of the candidate rehosting state to an aggregate proximity parameter value of the application characterizing dataset that characterizes the microservice based application hosted in the source state.

12. A system comprising:
a memory;
at least one processor in communication with the memory; and
program instructions executable by one or more processor via the memory to perform operations comprising:
establishing, for a microservice defining a microservice based application hosted in a source state, edge characterizing data that characterizes a relationship of the microservice to respective ones of remaining microservices defining the microservice based application, wherein the establishing is performed in dependence on observatory data obtained for the microservice based application hosted in the source state;
repeating the establishing for second to Nth microservices defining the microservice based application, and outputting from the repeating an application characterizing dataset that characterizes the microservice based application hosted in the source state;
generating a plurality of candidate rehosting states for the microservice based application;
for respective ones of the candidate rehosting states, producing a candidate application characterizing dataset;
identifying, in dependence on the producing, a suitable rehosting state from the plurality of candidate rehosting states; and
rehosting the microservice based application for implementation of the suitable rehosting state identified by the identifying.

13. The system of claim 12, wherein the producing the candidate application characterizing data for the respective ones of the candidate rehosting states includes performing the producing in dependence on predicted observatory data predicted for the respective ones of the candidate rehosting states.

14. The system of claim 12, wherein the operations include training a predictive model using data of the observatory data, wherein the producing the candidate application characterizing data for the respective ones of the candidate rehosting states includes performing the producing in dependence on predicted observatory data predicted for the respective ones of the candidate rehosting states, wherein obtaining the predicted observatory data predicted for at least one of the candidate rehosting states includes inferencing the predictive model.

15. The system of claim 12, wherein the characterizing data that characterizes a relationship of the microservice to respective ones of remaining microservices defining the microservice based application includes proximity parameter values that are determined based on logging data and metrics data of the observatory data obtained for the microservice based application hosted in the source state.

16. The system of claim 12, wherein the characterizing data that characterizes a relationship of the microservice to respective ones of remaining microservices defining the microservice based application includes a proximity parameter value that characterizes a relationship between the microservice and a certain remaining microservice of the remaining microservice, wherein the proximity parameter value is determined in dependence on messaging latency between the microservice and the certain remaining microservice and on shared resources between the microservice and the certain remaining resources.

17. The system of claim 12, wherein identifying the suitable rehosting state from the candidate rehosting states includes comparing data of the candidate application characterizing dataset produced for respective ones of the candidate rehosting state to data of the application characterizing dataset that characterizes the microservice based application hosted in the source state.

18. The system of claim 12, wherein identifying the suitable rehosting state from the candidate rehosting states includes comparing an aggregate proximity parameter value of the candidate application characterizing dataset produced for respective ones of the candidate rehosting state to an aggregate proximity parameter value of the application characterizing dataset that characterizes the microservice based application hosted in the source state.

19. The system of claim 12, wherein the operations include discovering that characterizing data that characterizes a relationship between the microservice and a particular microservice of the remaining microservices satisfies one or more criterion, and wherein the generating includes performing the generating in dependence on the discovering.

20. A computer program product comprising:
a computer readable storage medium readable by one or more processing circuit and storing instructions for execution by one or more processor for performing a method comprising:
establishing, for a microservice defining a microservice based application hosted in a source state, edge characterizing data that characterizes a relationship of the microservice to respective ones of remaining microservices defining the microservice based application, wherein the establishing is performed in dependence on observatory data obtained for the microservice based application hosted in the source state;
repeating the establishing for second to Nth microservices defining the microservice based application, and outputting from the repeating an application characterizing dataset that characterizes the microservice based application hosted in the source state;
generating a plurality of candidate rehosting states for the microservice based application;
for respective ones of the candidate rehosting states, producing a candidate application characterizing dataset;
identifying, in dependence on the producing, a suitable rehosting state from the plurality of candidate rehosting states; and
rehosting the microservice based application for implementation of the suitable rehosting state identified by the identifying.
